(19) United States
(12) Patent Application Publication
(10) Pub. No.: US 2025/0109277 A1
(43) Pub. Date: Apr. 3, 2025

(54) CYCLIC OLEFIN RESIN COMPOSITION, MOLDED ARTICLE, AND OPTICAL COMPONENT

(71) Applicant: MITSUI CHEMICALS, INC., Chuo-ku, Tokyo (JP)

(72) Inventors: Yuya HAMADA, Chiba-shi, Chiba (JP); Yasuyuki SOEDA, Alexandra View (SG); Futoshi FUJIMURA, Ichihara-shi, Chiba (JP); Masakatsu KASUYA, Chiba-shi, Chiba (JP); Takayuki OKUNO, Ichihara-shi, Chiba (JP)

(73) Assignee: MITSUI CHEMICALS, INC., Chuo-ku, Tokyo (JP)

(21) Appl. No.: 18/836,399

(22) PCT Filed: Feb. 2, 2023
(86) PCT No.: PCT/JP2023/003357

§ 371 Date: Aug. 7, 2024

(30) Foreign Application Priority Data
Feb. 9, 2022 (JP) 2022-018537

(51) Int. Cl. C08K 5/55; C08F 232/08; G02B 1/04

(52) U.S. Cl. CPC C08K 5/55; C08F 232/08; G02B 1/041; C08F 2500/25

(57) ABSTRACT

A cyclic olefin resin composition of the present invention contains a cyclic olefin copolymer (A) and a boric acid ester compound (B).

### TECHNICAL FIELD

The present invention relates to a cyclic olefin resin composition, a molded article, and an optical component.

### BACKGROUND ART

A cyclic olefin copolymer is used for optical lenses such as an imaging lens, an fθ lens, and a pickup lens, for example. The cyclic olefin copolymer used for molded articles such optical lenses is required to have high transparency, excellent dimensional stability, excellent heat resistance, excellent moisture resistance, excellent moist heat resistance, and other characteristics.

Examples of a resin composition containing such a cyclic olefin copolymer include a resin composition described in Patent Document 1. In Patent Document 1, disclosed is a cyclic olefin resin composition contains a cyclic olefin polymer (A) and triglycerin fatty acid ester.

### RELATED DOCUMENT

### Patent Document

[Patent Document 1] Japanese Unexamined Patent Publication No. 2018-172665

### SUMMARY OF THE INVENTION

### Technical Problem

In recent years, cyclic olefin copolymers have been required to have durability under a moist heat resistance test harsher than 80° C. and 90% RH, for example, as disclosed in Patent Document 1. There is an issue in that when the cyclic olefin copolymer does not contain an additive disclosed in Patent Document 1, the cyclic olefin copolymer does not satisfy the required moist heat resistance, resulting in an occurrence of fine cracks in a cyclic olefin resin under high temperature and high humidity, and an increase in internal haze. On the other hand, depending on the kind of additives, there is also an issue of poor compatibility with the cyclic olefin resin.

In addition, when a molded article such as a lens is molded with a cyclic olefin resin composition, there is an issue in that a mold is contaminated due to volatilization and bleeding of additives, which causes a significant decrease in productivity.

The present invention has been made in view of the above circumstances, and an object of the present invention is to provide a cyclic olefin resin composition that can provide an optical molded article having excellent moist heat resistance and less mold contamination.

### Solution to Problem

According to the present invention, provided are a cyclic olefin resin composition, a molded article, and an optical component described below.

[1]

A cyclic olefin resin composition containing;
a cyclic olefin copolymer (A); and
a boric acid ester compound (B).
   [2]

The cyclic olefin resin composition according to [1],
in which the cyclic olefin copolymer (A) has a repeating unit (a) derived from at least one olefin represented by General Formula (I), and a repeating unit (b) derived from at least one cyclic olefin monomer selected from the group consisting of a repeating unit (AA) represented by General Formula (II), a repeating unit (AB) represented by General Formula (III), and a repeating unit (AC) represented by General Formula (IV),

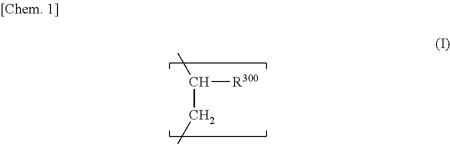

(in General Formula (I), R³⁰⁰ represents a hydrogen atom or a linear or branched hydrocarbon group having 1 to 29 carbon atoms),

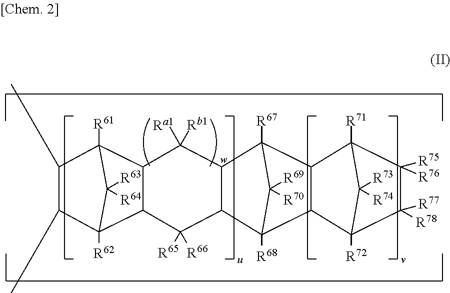

(in General Formula (II), u is 0 or 1, v is 0 or a positive integer, w is 0 or 1, R⁶¹ to R⁷⁸ and R^{a1} and R^{b1} may be the same or different from each other and are each a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded to each other to form a monocyclic ring or a polycyclic ring),

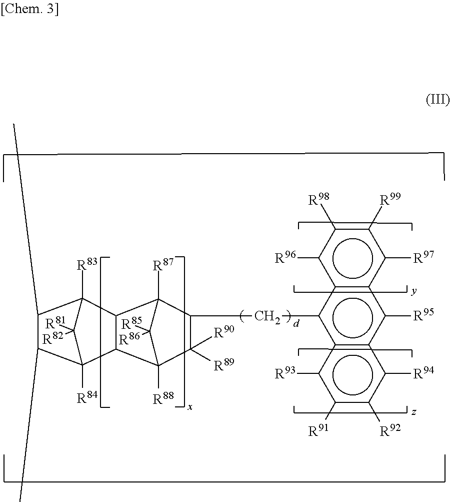

(in General Formula (III), x and d are each 0 or an integer of equal to or more than 1, y and z are each 0, 1, or 2, R⁸¹ to R⁹⁹ may be the same or different from each other and are each a hydrogen atom, a halogen atom, an aliphatic hydrocarbon group that is an alkyl group having 1 to 20 carbon atoms or a cycloalkyl group having 3 to 15 carbon atoms, an aromatic hydrocarbon group having 6 to 20 carbon atoms or an alkoxy group, a carbon atom to which R⁸⁹ and R⁹⁰ are bonded may be bonded to a carbon atom to which R⁹³ is bonded or a carbon atom to which R⁹¹ is bonded directly or through an alkylene group having 1 to 3 carbon atoms, and provided that y=z=0, R⁹⁵ and R⁹² or R⁹⁵ and R⁹⁹ may be bonded to each other to form a monocyclic aromatic ring or a polycyclic aromatic ring),

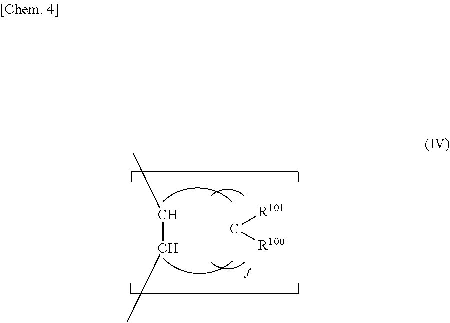

(in General Formula (IV), R¹⁰⁰ and R¹⁰¹ may be the same or different from each other and each represent a hydrogen atom or a hydrocarbon group having 1 to 5 carbon atoms, and f is 1≤f≤18).
   [3]

The cyclic olefin resin composition according to [1],
in which the cyclic olefin copolymer (A) has the repeating unit (AA) represented by General Formula (II), and a constituent unit (C) derived from a cyclic olefin having an aromatic ring,
the repeating unit (AA) has no aromatic ring, and
the cyclic olefin having an aromatic ring includes one or two or more compounds selected from the group consisting of a compound represented by General Formula (C-1), a compound represented by General Formula (C-2), and a compound represented by General Formula (C-3),

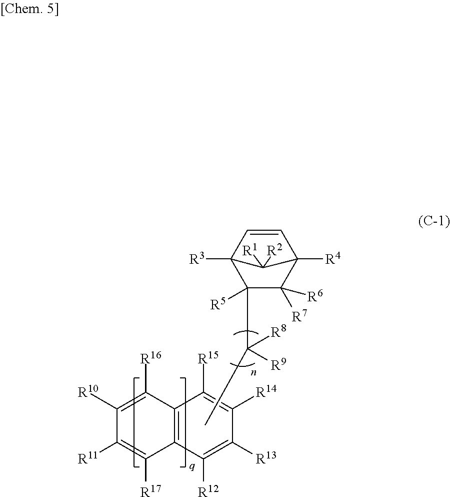

(in General Formula (C-1), n and q are each independently 0, 1, or 2; R¹ to R¹⁷ are each independently a hydrogen atom, a halogen atom other than a fluorine atom, or a hydrocarbon group having 1 to 20 carbon atoms which may be substituted with a halogen atom other than a fluorine atom, and one of R¹⁰ to R¹⁷ is a bonding site, provided that q=0, R¹⁰ and R¹¹, R¹¹ and R¹², R¹² and R¹³, R¹³ and R¹⁴, R¹⁴ and R¹⁵, or R¹⁵ and R¹⁰ may be bonded to each other to form a monocyclic ring or a polycyclic ring, and provided that q=1 or 2, R¹⁰ and R¹¹, R¹¹ and R¹⁷, R¹⁷ and R¹⁷, R¹⁷ and R¹², R¹² and R¹³, R¹³ and R¹⁴, R¹⁴ and R¹⁵, R¹⁵ and R¹⁶, R¹⁶ and R¹⁶, or R¹⁶ and R¹⁰ may be bonded to each other to form a monocyclic ring or a polycyclic ring, where the monocyclic ring or the polycyclic ring may have a double bond, and the monocyclic ring or the polycyclic ring may be an aromatic ring),

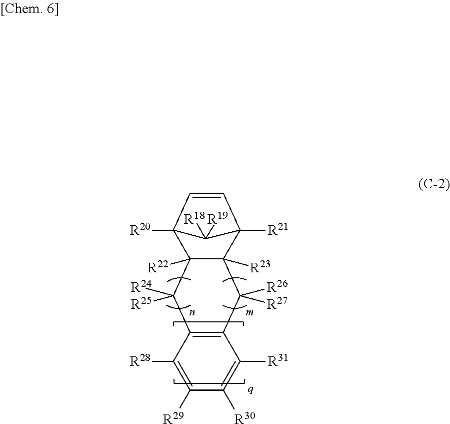

(in General Formula (C-2), n and m are each independently 0, 1, or 2, q is 1, 2, or 3, R¹⁸ to R³¹ are each independently a hydrogen atom, a halogen atom other than a fluorine atom, or a hydrocarbon group having 1 to 20 carbon atoms which may be substituted with a halogen atom other than a fluorine atom, provided that q=1, R²⁸ and R²⁹, R²⁹ and R³⁰, and R³⁰ and R³¹ may be bonded to each other to form a monocyclic ring or a polycyclic ring, and provided that q=2 or 3, R²⁸ and R²⁸, R²⁸ and R²⁹, R²⁹ and R³⁰, R³⁰ and R³¹, and R³¹ and R³¹ may be bonded to each other to form a monocyclic ring or a polycyclic ring, where the monocyclic ring or the polycyclic ring may have a double bond, and the monocyclic ring or the polycyclic ring may be an aromatic ring),

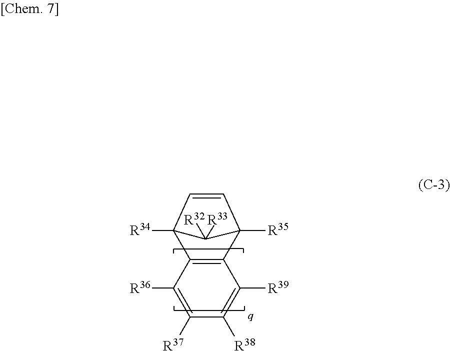

(in General Formula (C-3), q is 1, 2, or 3, R³² to R³⁹ are each independently a hydrogen atom, a halogen atom excluding a fluorine atom, or a hydrocarbon group having 1 to 20 carbon atoms, which may be substituted with a halogen atom excluding a fluorine atom, and provided that q=1, R³⁶ and R³⁷, R³⁷ and R³⁸, and R³⁸ and R³⁹ may be bonded to each other to form a monocyclic ring or a polycyclic ring and in a case of q=2 or 3, R³⁶ and R³⁶, R³⁶ and R³⁷, R³⁷ and R³⁸, R³⁸ and R³⁹, and R³⁹ and R³⁹ may be bonded to each other to form a monocyclic ring or a polycyclic ring, where the monocyclic ring or the polycyclic ring may have a double bond, and the monocyclic ring or the polycyclic ring may be an aromatic ring).
   [4]

The cyclic olefin resin composition according to any one of [1] to [3],
in which the boric acid ester compound (B) includes a compound represented by Structural Formula (B-1),

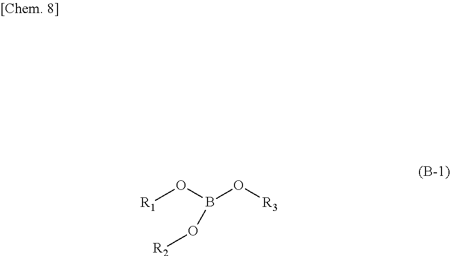

(in Structural Formula (B-1), R₁, R₂, and R₃ each represent a functional group having 11 or more carbon atoms, which includes a carbon atom, a hydrogen atom, and an oxygen atom, or a hydrogen atom, at least one of R₁, R₂, or R₃ is a functional group having 11 or more carbon atoms, which includes a carbon atom, a hydrogen atom, and an oxygen atom, and may include a nitrogen atom, and R₁, R₂, and R₃ may form a ring with each other).
   [5]

The cyclic olefin resin composition according to any one of [1] to [4],
in which a content of the boric acid ester compound (B) is equal to or more than 0.05 parts by mass and equal to or less than 10.0 parts by mass, given that a content of the cyclic olefin copolymer (A) contained in the cyclic olefin resin composition is 100 parts by mass.
   [6]

The cyclic olefin resin composition according to any one of [1] to [5],
in which the boric acid ester compound (B) includes a compound represented by Formula (B-2),

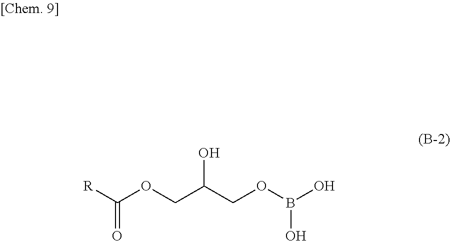

(in Formula (B-2), R is an alkyl group or an alkenyl group represented by CₙH₂ₙ₊₁ or CₙH₂ₙ₋₁, and n in R is equal to or more than 8 and equal to or less than 22).
   [7]

The cyclic olefin resin composition according to any one of [1] to [5],
in which the boric acid ester compound (B) includes a donor-acceptor compound represented by Formula (B-4) or Formula (B-5),

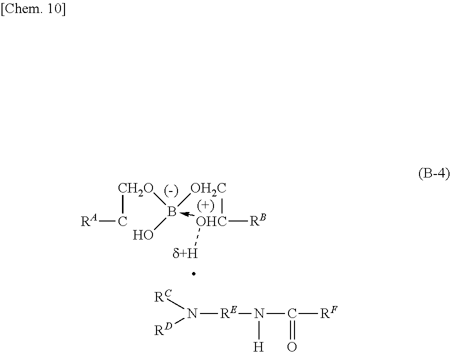

(in Formula (B-4), R^{A} and R^{B} are each independently an alkyl group having 8 to 21 carbon atoms, R^{G}CO—OCH₂—, or HOCH₂—, at least one of R^{A} or R^{B} is an alkyl group having 10 to 21 carbon atoms or R^{G}CO—OCH₂—, R^{C} and R^{D} are each independently CH₃—, C₂H₅—, HOCH₂—, HOC₂H₄—, or HOCH₂CH(CH₃)—, R^{E} is CₙH₂ₙ (n is equal to or more than 2 and equal to or less than 10), and R^{F} and R^{G} are each independently an alkyl group having 10 to 21 carbon atoms),

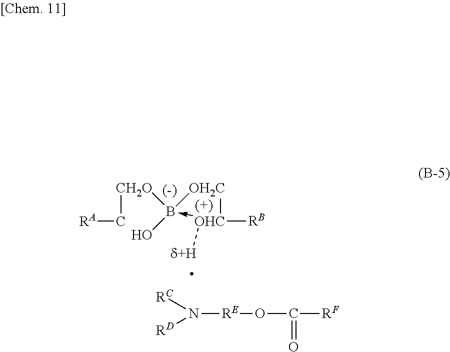

(in Formula (B-5), R^{A} and R^{B} are each independently an alkyl group having 8 to 21 carbon atoms, R^{G}CO—OCH₂—, or HOCH₂—, at least one of R^{A} or R^{B} is an alkyl group having 10 to 21 carbon atoms or R^{G}CO—OCH₂—, R^{C} and R^{D} are each independently CH₃—, C₂H₅—, HOCH₂—, HOC₂H₄—, or HOCH₂CH(CH₃)—, R^{E} is CₙH₂ₙ (n is equal to or more than 2 and equal to or less than 10), and R^{F} and R^{G} are each independently an alkyl group having 10 to 21 carbon atoms).
   [8]

A molded article containing the cyclic olefin resin composition according to any one of [1] to [7].

[9]

An optical component including the molded article according to [8].

### Advantageous Effects of Invention

According to the present invention, it is possible to provide a cyclic olefin copolymer that can provide an optical molded article having excellent moist heat resistance and less mold contamination.

### DESCRIPTION OF EMBODIMENTS

Hereinafter, the present invention will be described based on embodiments. In the present embodiment, “A to B” indicating a numerical range represents equal to or more than A and equal to or less than B unless otherwise specified.

In addition, a “boric acid ester” in the present embodiment is a dehydrated condensate of boric acid and a compound having a hydroxyl group, and contains all of a monoester, a diester, and a triester.

### [Cyclic Olefin Resin Composition]

First, a cyclic olefin resin composition of an embodiment according to the present invention will be described.

The cyclic olefin resin composition according to the present embodiment contains a cyclic olefin copolymer (A) and a boric acid ester compound (B).

According to the cyclic olefin resin composition of the present embodiment, it is possible to achieve an optical molded article having excellent moist heat resistance and less mold contamination.

The reason for this is not clear but is presumed that the dispersibility of the boric acid ester compound (B) into the cyclic olefin copolymer (A) can be improved due to the fact that the boric acid ester compound (B) has high hydrophilicity and good compatibility with the cyclic olefin copolymer (A).

For the above reason, the cyclic olefin resin composition according to the present embodiment can be suitably used for the optical molded article.

The lower limit of a total content of the cyclic olefin copolymer (A) and the boric acid ester compound (B) in the cyclic olefin resin composition according to the present embodiment is preferably equal to or more than 70 parts by mass, more preferably equal to or more than 80 parts by mass, even more preferably equal to or more than 90 parts by mass, and particularly preferably equal to or more than 95 parts by mass, given that a total mass of the cyclic olefin resin composition is 100 parts by mass. By setting the total content of the cyclic olefin copolymer (A) and the boric acid ester compound (B) in the cyclic olefin resin composition according to the present embodiment within the range of equal to or more than the above lower limit values, the optical performance can be further improved.

Although not particularly limited, the upper limit of the total content of the cyclic olefin copolymer (A) and the boric acid ester compound (B) in the cyclic olefin resin composition according to the present embodiment is, for example, equal to or less than 100 parts by mass.

Hereinafter, each component will be specifically described.

### (Cyclic Olefin Copolymer (A))

### First Embodiment

From the viewpoint that moist heat resistance can be further improved and moldability can be improved while maintaining a good performance balance of transparency and a refractive index of a molded article obtained, a cyclic olefin copolymer (A) according to a first embodiment of the present invention preferably contains a repeating unit (a) derived from at least one olefin represented by General Formula (I), and a repeating unit (b) derived from at least one cyclic olefin monomer selected from the group consisting of a repeating unit (AA) represented by General Formula (II), a repeating unit (AB) represented by General Formula (III), and a repeating unit (AC) represented by General Formula (IV).

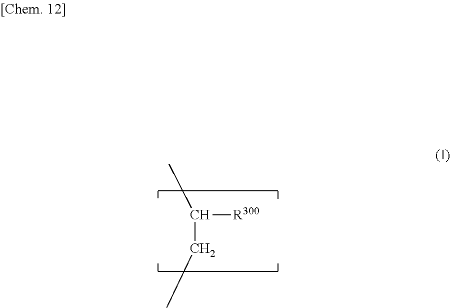

In the above General Formula (I), R³⁰⁰ represents a hydrogen atom or a linear or branched hydrocarbon group having 1 to 29 carbon atoms.

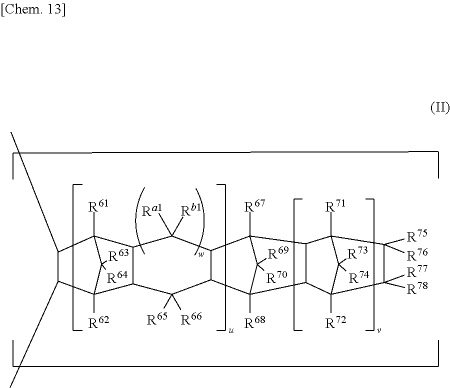

In General Formula (II), u is 0 or 1, v is 0 or a positive integer, preferably an integer of 0 or more and 2 or less and more preferably 0 or 1, w is 0 or 1, R⁶¹ to R⁷⁸, R^{a1}, and R^{b1} may be the same or different from each other and are each a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded to each other to form a monocyclic ring or a polycyclic ring.

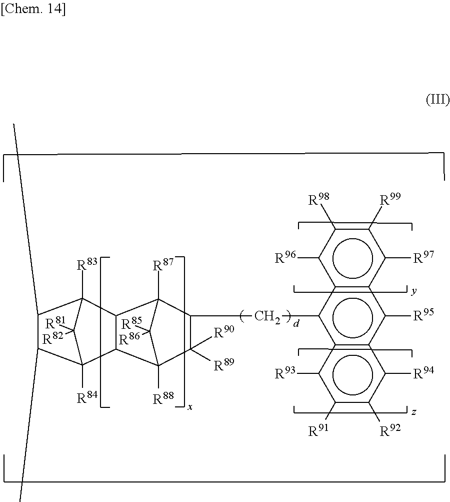

In General Formula (III), x and d are each 0 or an integer of equal to or more than 1, preferably an integer of equal to or more than 0 and equal to or less than 2, and more preferably 0 or 1, y and z are each 0, 1, or 2, R⁸¹ to R⁹⁹ may be the same or different from each other and are each a hydrogen atom, a halogen atom, an aliphatic hydrocarbon group that is an alkyl group having 1 to 20 carbon atoms or a cycloalkyl group having 3 to 15 carbon atoms, an aromatic hydrocarbon group having 6 to 20 carbon atoms or an alkoxy group, a carbon atom to which R⁸⁹ and R⁹⁰ are bonded may be bonded to a carbon atom to which R⁹³ is bonded or a carbon atom to which R⁹¹ is bonded directly or through an alkylene group having 1 to 3 carbon atoms, and provided that y=z=0, R⁹⁵ and R⁹² or R⁹⁵ and R⁹⁹ may be bonded to each other to form a monocyclic aromatic ring or a polycyclic aromatic ring.

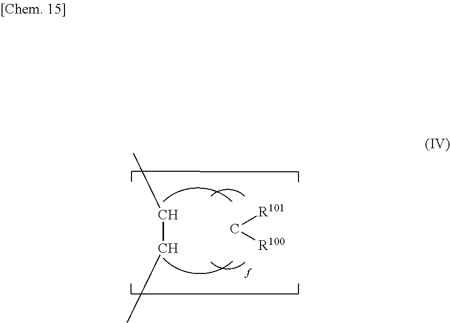

In General Formula (IV), R¹⁰⁰ and R¹⁰¹ may be the same or different from each other and each represent a hydrogen atom or a hydrocarbon group having 1 to 5 carbon atoms, and f is 1≤f≤18.

An olefin monomer, which is a copolymerization raw material of the cyclic olefin copolymer (A) according to the first embodiment of the present invention, undergoes an addition polymerization to form a repeating unit (a) represented by General Formula (I) described above. Specifically, an olefin monomer represented by General Formula (Ia) corresponding to General Formula (I) is used.

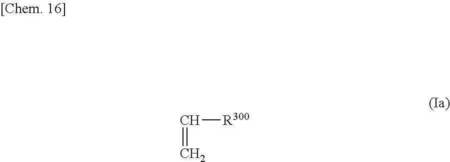

In General Formula (Ia), R³⁰⁰ represents a hydrogen atom or a linear or branched hydrocarbon group having 1 to 29 carbon atoms. Examples of the olefin monomer represented by General Formula (Ia) include ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicosene, and the like. Among these, ethylene and propylene are preferable, and ethylene is particularly preferable, from the viewpoint of obtaining a molded article having more excellent moist heat resistance, mechanical characteristics, and optical characteristics. Two or more olefin monomers represented by General Formula (Ia) may be used. In addition, as the olefin monomer, at least one or more biomass-derived monomers (ethylene, propylene, and α-olefin) may be contained.

Given that a total amount of the repeating units constituting the cyclic olefin copolymer according to the first embodiment of the present invention is 100% by mol, the upper limit value of the proportion of the repeating unit (a) derived from olefin is preferably equal to or less than 95% by mol, more preferably equal to or less than 90% by mol, even more preferably equal to or less than 85% by mol, and even more preferably equal to or less than 80% by mol, from the viewpoint of obtaining a molded article having more excellent moist heat resistance, mechanical characteristics, and optical characteristics.

In addition, given that the total amount of the repeating units constituting the cyclic olefin copolymer according to the first embodiment of the present invention is 100% by mol, the lower limit value of the proportion of the repeating unit (a) derived from olefin is preferably equal to or more than 5% by mol, more preferably equal to or more than 10% by mol, even more preferably equal to or more than 20% by mol, even more preferably equal to or more than 30% by mol, even more preferably equal to or more than 40% by mol, and even more preferably equal to or more than 50% by mol, from the viewpoint of obtaining a molded article having more excellent moist heat resistance, mechanical characteristics, and optical characteristics.

Furthermore, given that the total amount of the repeating units constituting the cyclic olefin copolymer according to the first embodiment of the present invention is 100% by mol, the proportion of the repeating unit (a) derived from olefin is preferably equal to or more than 5% by mol and equal to or less than 95% by mol, more preferably equal to or more than 10% by mol and equal to or less than 95% by mol, even more preferably equal to or more than 20% by mol and equal to or less than 90% by mol, even more preferably equal to or more than 30% by mol and equal to or less than 90% by mol, even more preferably equal to or more than 40% by mol and equal to or less than 85% by mol, and even more preferably equal to or more than 50% by mol and equal to or less than 80% by mol, from the viewpoint of obtaining a molded article having more excellent moist heat resistance, mechanical characteristics, and optical characteristics.

The proportion of the repeating unit (a) derived from olefin can be measured by ¹³C-NMR.

The cyclic olefin monomer, which is one of the copolymerization raw materials of the cyclic olefin copolymer (A) according to the first embodiment of the present invention, undergoes an addition polymerization to form a repeating unit (b) derived from a cyclic olefin monomer represented by General Formula (II), General Formula (III), or General Formula (IV). Specifically, a cyclic olefin monomer represented by General Formula (IIa), General Formula (IIIa), or General Formula (IVa), each corresponding to General Formula (II), General Formula (III), or General Formula (IV) described above, is used.

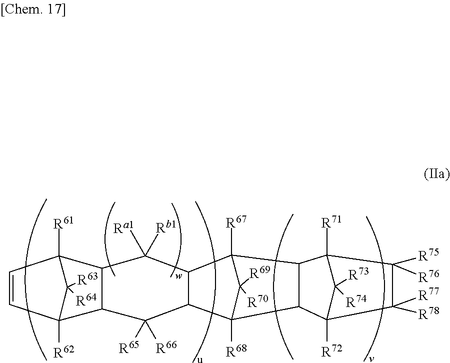

In General Formula (IIa), u is 0 or 1; v is 0 or a positive integer, preferably an integer of 0 or more and 2 or less and more preferably 0 or 1; w is 0 or 1; R⁶¹ to R⁷⁸, R^{a1}, and R^{b1} may be the same or different from each other, and are each a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms; and R⁷⁵ to R⁷⁸ may be bonded to each other to form a monocyclic ring or a polycyclic ring.

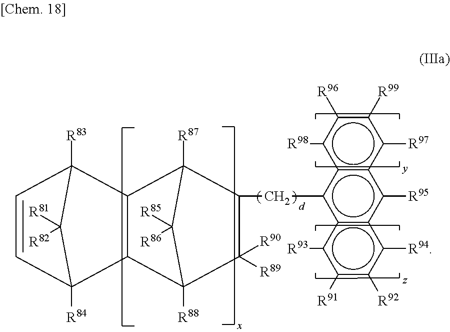

In General Formula (IIIa), x and d are each 0 or an integer of equal to or more than 1, preferably an integer of equal to or more than 0 and equal to or less than 2, and more preferably 0 or 1, y and z are each 0, 1, or 2, R⁸¹ to R⁹⁹ may be the same or different from each other and are each a hydrogen atom, a halogen atom, an aliphatic hydrocarbon group that is an alkyl group having 1 to 20 carbon atoms or a cycloalkyl group having 3 to 15 carbon atoms, an aromatic hydrocarbon group having 6 to 20 carbon atoms or an alkoxy group, a carbon atom to which R⁸⁹ and R⁹⁰ are bonded may be bonded to a carbon atom to which R⁹³ is bonded or a carbon atom to which R⁹¹ is bonded directly or through an alkylene group having 1 to 3 carbon atoms, and provided that y=z=0, R⁹⁵ and R⁹² or R⁹⁵ and R⁹⁹ may be bonded to each other to form a monocyclic aromatic ring or a polycyclic aromatic ring.

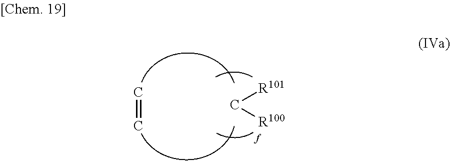

In General Formula (IVa), R¹⁰⁰ and R¹⁰¹ may be the same or different from each other and each represent a hydrogen atom or a hydrocarbon group having 1 to 5 carbon atoms, and f is 1≤f≤18.

Since the olefin monomer represented by General Formula (Ia) described above and the cyclic olefin monomer represented by General Formula (IIa), (IIIa), or (IVa) are used as a copolymerization component to further improve the solubility of the cyclic olefin copolymer (A) in a solvent, the moldability is improved, and the yield of the article is improved.

Regarding specific examples of the cyclic olefin monomers represented by General Formula (IIa), (IIIa), or (IVa), compounds described in paragraphs 0037 to 0063 of Pamphlet of International Publication No. WO2006/118261 can be used. The above-described cyclic olefin monomers are obtained from dicyclopentadiene and ethylene, and may contain, as the ethylene, a unit derived from a biomass-derived monomer (ethylene).

Specifically, examples thereof include bicyclo-2-heptene derivatives (bicyclohept-2-ene derivatives), tricyclo-3-decene derivatives, tricyclo-3-undecene derivatives, tetracyclo-3-dodecene derivatives, pentacyclo-4-pentadecene derivatives, pentacyclo pentadecadien derivatives, pentacyclo-3-pentadecene derivatives, pentacyclo-4-hexadecene derivatives, pentacyclo-3-hexadecene derivatives, hexacyclo-4-heptadecene derivatives, heptacyclo-5-eicosene derivatives, heptacyclo-4-eicosene derivatives, heptacyclo-5-heneicosene derivatives, octacyclo-5-docosene derivatives, nonacyclo-5-pentacosene derivatives, nonacyclo-6-hexacosene derivatives, cyclopentadiene-acenaphthylene adducts, 1,4-methano-1,4,4a,9a-tetrahydrofluorene derivatives, 1,4-methano-1,4,4a,5,10,10a-hexahydroanthracene derivatives, cycloalkylene derivatives having 3 to 20 carbon atoms, and the like.

Among the cyclic olefin monomers represented by General Formulae (IIa), (IIIa), and (IVa), the cyclic olefin represented by General Formula (IIa) is preferable.

In addition, it is preferable to use the cyclic olefin represented by General Formula (IIa) and a cyclic olefin represented by either General Formula (IIIa) or (IVa).

As the cyclic olefin monomer represented by General Formula (IIa), bicyclo[2.2.1]-2-heptene (also referred to as norbornene) or tetracyclo[4.4.0.1^{2,5}.1^{7,10}]-3-dodecene (also referred to as tetracyclododecene) is preferably used, and tetracyclo[4.4.0.1^{2,5}.1^{7,10}]-3-dodecene is more preferably used. There is an advantage that elastic modulus of each of the copolymer and the molded article can be easily maintained because such a cyclic olefin has a rigid ring structure.

Given that the total amount of the repeating units constituting the cyclic olefin copolymer according to the first embodiment of the present invention is 100% by mol, the upper limit value of the proportion of the repeating unit (b) derived from cyclic olefin is preferably equal to or less than 95% by mol, more preferably equal to or less than 90% by mol, even more preferably equal to or less than 80% by mol, even more preferably equal to or less than 70% by mol, even more preferably equal to or less than 60% by mol, and even more preferably equal to or less than 50% by mol, from the viewpoint of obtaining a molded article having more excellent moist heat resistance, mechanical characteristics, and optical characteristics.

In addition, given that a total amount of the repeating units constituting the cyclic olefin copolymer according to the first embodiment of the present invention is 100% by mol, the lower limit value of the proportion of the repeating unit (b) derived from cyclic olefin is preferably equal to or more than 5% by mol, more preferably equal to or more than 10% by mol, even more preferably equal to or more than 15% by mol, and even more preferably equal to or more than 20% by mol, from the viewpoint of obtaining a molded article having more excellent moist heat resistance, mechanical characteristics, and optical characteristics.

Furthermore, given that the total amount of the repeating units constituting the cyclic olefin copolymer (A) according to the first embodiment of the present invention is 100% by mol, the proportion of the repeating unit (b) derived from a cyclic olefin monomer is preferably equal to or more than 5% by mol and equal to or less than 95% by mol, more preferably equal to or more than 5% by mol and equal to or less than 90% by mol, even more preferably equal to or more than 10% by mol and equal to or less than 80% by mol, even more preferably equal to or more than 10% by mol and equal to or less than 70% by mol, even more preferably equal to or more than 15% by mol and equal to or less than 60% by mol, and even more preferably equal to or more than 20% by mol and equal to or less than 50% by mol, from the viewpoint of obtaining a molded article having more excellent moist heat resistance, mechanical characteristics, and optical characteristics.

The proportion of the repeating unit (b) derived from a cyclic olefin can be measured by ¹³C-NMR.

A copolymerization type of the cyclic olefin copolymer (A) according to the first embodiment of the present invention is not particularly limited, and examples thereof include a random copolymer, a block copolymer, and the like. In the first embodiment of the present invention, it is preferable to use a random copolymer as the cyclic olefin copolymer (A) according to the first embodiment of the present invention, from the viewpoint capable of obtaining a highly accurate optical component whose optical properties such as transparency, refractive index, and birefringence index are excellent.

Examples of the cyclic olefin copolymer (A) according to the first embodiment of the present invention preferably include a random copolymer of ethylene and tetracyclo[4.4.0.1^{2,5}.1^{7,10}]-3-dodecene, a random copolymer of ethylene and bicyclo[2.2.1]-2-heptene, and a random copolymer of ethylene, tetracyclo[4.4.0.1^{2,5}.1^{7,10}]-3-dodecene, and benzonorbornadiene, and more preferably include a random copolymer of ethylene and tetracyclo[4.4.0.1^{2,5}.1^{7,10}]-3-dodecene, and a random copolymer of ethylene, tetracyclo[4.4.0.1^{2,5},1^{7,10}]-3-dodecene, and benzonorbornadiene.

In the first embodiment of the present invention, the cyclic olefin copolymer (A) may be used alone, or two or more types of the cyclic olefin copolymer (A) may be used in combination.

The cyclic olefin copolymer (A) according to the first embodiment of the present invention can be produced, for example, by appropriately selecting conditions according to the methods of Japanese Unexamined Patent Publication No. 60-168708, Japanese Unexamined Patent Publication No. 61-120816, Japanese Unexamined Patent Publication No. 61-115912, Japanese Unexamined Patent Publication No. 61-115916, Japanese Unexamined Patent Publication No. 61-271308, Japanese Unexamined Patent Publication No. 61-272216, Japanese Unexamined Patent Publication No. 62-252406, Japanese Unexamined Patent Publication No. 62-252407, and the like.

### Second Embodiment

From the viewpoint that moist heat resistance can be further improved and moldability can be improved while maintaining a good performance balance of transparency and a refractive index of a molded article obtained, the cyclic olefin copolymer (A) according to a second embodiment of the present invention preferably has the repeating unit (AA) represented by General Formula (II) and a constituent unit (C) derived from a cyclic olefin having an aromatic ring, the repeating unit (AA) having no aromatic ring, and the cyclic olefin having an aromatic ring being composed of one or two or more compounds selected from the group consisting of a compound represented by General Formula (C-1), a compound represented by General Formula (C-2), and a compound represented by General Formula (C-3).

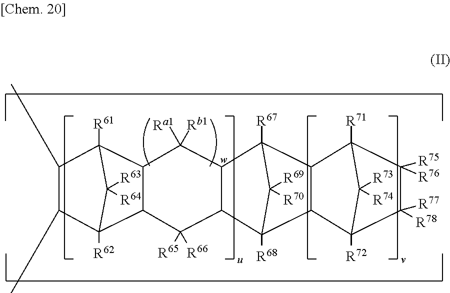

In General Formula (II), u is 0 or 1, v is 0 or a positive integer, w is 0 or 1, R⁶¹ to R⁷⁸ and R^{a1} and R^{b1} may be the same or different from each other and are each a hydrogen atom, a halogen atom, an alkyl group having 1 to 20 carbon atoms, a halogenated alkyl group having 1 to 20 carbon atoms, or a cycloalkyl group having 3 to 15 carbon atoms, and R⁷⁵ to R⁷⁸ may be bonded to each other to form a monocyclic ring or a polycyclic ring.

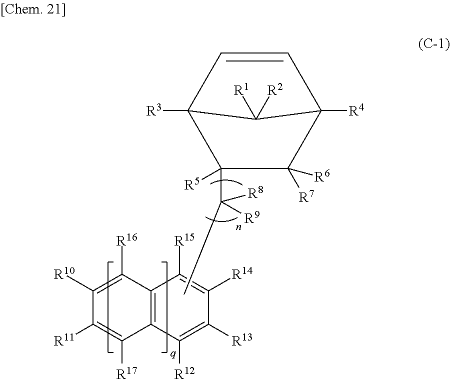

In General Formula (C-1), n and q are each independently 0, 1, or 2; R¹ to R¹⁷ are each independently a hydrogen atom, a halogen atom other than a fluorine atom, or a hydrocarbon group having 1 to 20 carbon atoms which may be substituted with a halogen atom other than a fluorine atom, and one of R¹⁰ to R¹⁷ is a bonding site; provided that q=0, R¹⁰ and R¹¹, R¹¹ and R¹². R¹² and R¹³, R¹³ and R¹⁴, R¹⁴ and R¹⁵, or R¹⁵ and R¹⁰ may be bonded to each other to form a monocyclic ring or a polycyclic ring, and provided that q=1 or 2, R¹⁰ and R¹¹, R¹¹ and R¹⁷, R¹⁷ and R¹⁷, R¹⁷ and R¹², R¹² and R¹³, R¹³ and R¹⁴, R¹⁴ and R¹⁵, R¹⁵ and R¹⁶, R¹⁶ and R¹⁶, or R¹⁶ and R¹⁰ may be bonded to each other to form a monocyclic ring or a polycyclic ring, where the monocyclic ring or the polycyclic ring may have a double bond, and the monocyclic ring or the polycyclic ring may be an aromatic ring.

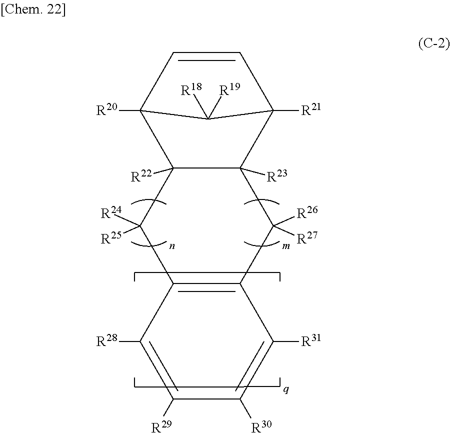

In General Formula (C-2), n and m are each independently 0, 1, or 2, q is 1, 2, or 3, R¹⁸ to R³¹ are each independently a hydrogen atom, a halogen atom other than a fluorine atom, or a hydrocarbon group having 1 to 20 carbon atoms which may be substituted with a halogen atom other than a fluorine atom; provided that q=1, R²⁸ and R²⁹, R²⁹ and R³⁰, and R³⁰ and R³¹ may be bonded to each other to form a monocyclic ring or a polycyclic ring, and provided that q=2 or 3, R²⁸ and R²⁸, R²⁸ and R²⁹, R²⁹ and R³⁰, R³⁰ and R³¹, and R³¹ and R³¹ may be bonded to each other to form a monocyclic ring or a polycyclic ring, where the monocyclic ring or the polycyclic ring may have a double bond, and the monocyclic ring or the polycyclic ring may be an aromatic ring.

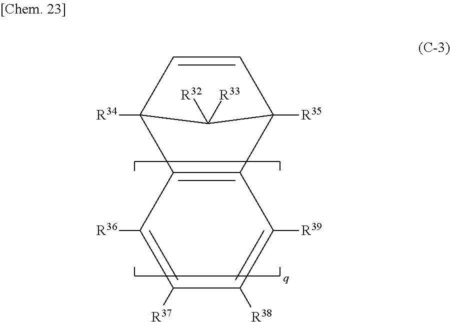

In General Formula (C-3), q is 1, 2, or 3, R³² to R³⁹ are each independently a hydrogen atom, a halogen atom excluding a fluorine atom, or a hydrocarbon group having 1 to 20 carbon atoms, which may be substituted with a halogen atom excluding a fluorine atom, and provided that q=1, R³⁶ and R³⁷, R³⁷ and R³⁸, and R³⁸ and R³⁹ may be bonded to each other to form a monocyclic ring or a polycyclic ring and provided that q=2 or 3, R³⁶ and R³⁶, R³⁶ and R³⁷, R³⁷ and R³⁸, R³⁸ and R³⁹, and R³⁹ and R³⁹ may be bonded to each other to form a monocyclic ring or a polycyclic ring, where the monocyclic ring or the polycyclic ring may have a double bond, and the monocyclic ring or the polycyclic ring may be an aromatic ring.

Since the cyclic olefin copolymer (A) according to the second embodiment of the present invention has the repeating unit (AA) represented by General Formula (II) and a constituent unit (C) derived from a cyclic olefin having an aromatic ring, the moist heat resistance can be further improved while maintaining transparency to be favorable.

(Repeating Unit (AA) Derived from Cyclic Olefin)

The repeating unit (AA) according to the second embodiment of the present invention is a repeating unit represented by General Formula (II). The repeating unit (AA) is included to enable the refractive index of a molded article obtained to be further improved.

The repeating unit (AA) according to the second embodiment of the present invention also includes no aromatic ring. The repeating unit (AA) includes no aromatic ring to enable the moldability of a molded article obtained to be further improved.

Given that the total content of the repeating unit (AA) and the constituent unit (C) in the cyclic olefin copolymer (A) according to the second embodiment of the present invention is 100% by mol, the lower limit value of the proportion of the repeating unit (AA) in the cyclic olefin copolymer (A) is preferably equal to or more than 5% by mol, more preferably equal to or more than 10% by mol, even more preferably equal to or more than 20% by mol, even more preferably equal to or more than 30% by mol, even more preferably equal to or more than 40% by mol, and even more preferably equal to or more than 50% by mol, from the viewpoint of obtaining a molded article having more excellent moist heat resistance, mechanical characteristics, and optical characteristics.

In addition, given that the total content of the repeating unit (AA) and the constituent unit (C) in the cyclic olefin copolymer (A) according to the second embodiment of the present invention is 100% by mol, the upper limit value of the proportion of the repeating unit (AA) in the cyclic olefin copolymer (A) is not particularly limited, and for example, equal to or less than 95% by mol from the viewpoint of obtaining a molded article having more excellent moist heat resistance, mechanical characteristics, and optical characteristics.

Furthermore, given that the total content of the repeating unit (AA) and the constituent unit (C) in the cyclic olefin copolymer (A) according to the second embodiment of the present invention is 100% by mol, the proportion of the repeating unit (AA) in the cyclic olefin copolymer (A) is preferably equal to or more than 5% by mol and equal to or less than 95% by mol, more preferably equal to or more than 10% by mol and equal to or less than 95% by mol, even more preferably equal to or more than 20% by mol and equal to or less than 95% by mol, even more preferably equal to or more than 30% by mol and equal to or less than 95% by mol, even more preferably equal to or more than 40% by mol and equal to or less than 95% by mol, and even more preferably equal to or more than 50% by mol and equal to or less than 95% by mol, from the viewpoint of obtaining a molded article having more excellent moist heat resistance, mechanical characteristics, and optical characteristics.

In the second embodiment of the present invention, the proportion of the repeating unit (AA) can be measured by, for example, ¹H-NMR or ¹³C-NMR.

(Constituent Unit (C) Derived from Cyclic Olefin Having Aromatic Ring)

The constituent unit (C) according to the second embodiment of the present invention is a constituent unit derived from a cyclic olefin having an aromatic ring.

Examples of the cyclic olefin having an aromatic ring according to the second embodiment of the present invention include a compound represented by General Formula (C-1), a compound represented by General Formula (C-2), a compound represented by General Formula (C-3), and the like. These cyclic olefins having an aromatic ring may be used alone, or two or more kinds thereof may be used in combination.

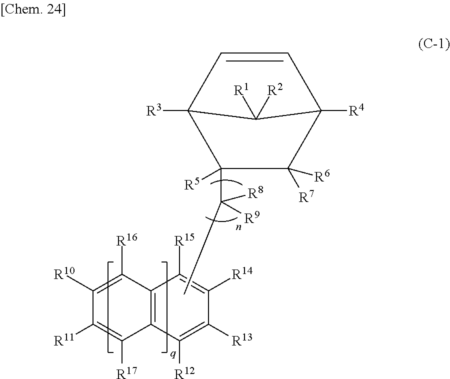

In General Formula (C-1), n and q are each independently 0, 1, or 2. n is preferably 0 or 1, and more preferably 0. q is preferably 0 or 1, and more preferably 0.

R¹ to R¹⁷ are each independently a hydrogen atom, a halogen atom other than a fluorine atom, or a hydrocarbon group having 1 to 20 carbon atoms which may be substituted with a halogen atom other than a fluorine atom, one of R¹⁰ to R¹⁷ is a bonding site, and R¹⁵ is preferably a bonding site.

R¹ to R¹⁷ are each independently preferably a hydrogen atom or a hydrocarbon group having 1 to 20 carbon atoms and more preferably a hydrogen atom.

Provided that q=0, R¹⁰ and R¹¹, R¹¹ and R¹², R¹² and R¹³, R¹³ and R¹⁴, R¹⁴ and R¹⁵, or R¹⁵ and R¹⁰ may be bonded to each other to form a monocyclic ring or a polycyclic ring, and provided that q=1 or 2, R¹⁰ and R¹¹, R¹¹ and R¹⁷, R¹⁷ and R¹⁷, R¹⁷ and R¹², R¹² and R¹³, R¹³ and R¹⁴, R¹⁴ and R¹⁵, R¹⁵ and R¹⁶, R¹⁶ and R¹⁶, or R¹⁶ and R¹⁰ may be bonded to each other to form a monocyclic ring or a polycyclic ring, where the monocyclic ring or the polycyclic ring may have a double bond, and the monocyclic ring or the polycyclic ring may be an aromatic ring.

In General Formula (C-1), a compound represented by General Formula (C-1A) is preferable.

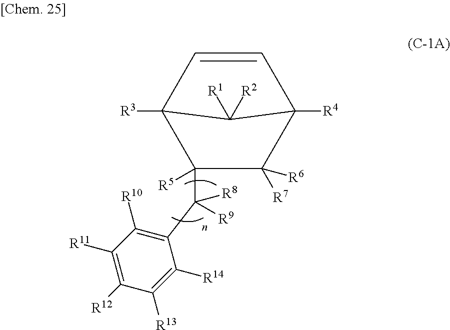

In General Formula (C-1A), n is 0, 1, or 2, preferably 0 or 1, and more preferably 0.

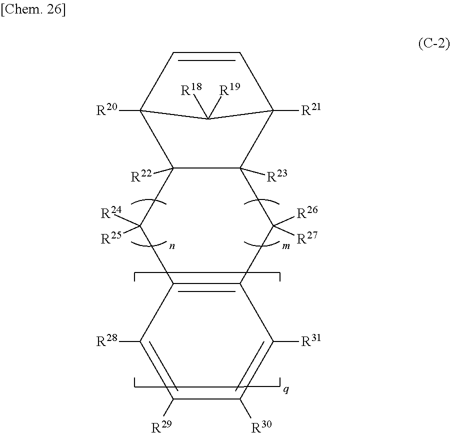

In General Formula (C-2), n and m are each independently 0, 1, or 2, q is 1, 2, or 3. m is preferably 0 or 1, and more preferably 1. n is preferably 0 or 1, and more preferably 0. q is preferably 1 or 2, and more preferably 1.

R¹⁸ to R³¹ are each independently a hydrogen atom, a halogen atom excluding a fluorine atom, or a hydrocarbon group having 1 to 20 carbon atoms, which may be substituted with a halogen atom excluding a fluorine atom.

R¹⁸ to R³¹ are each independently preferably a hydrogen atom or a hydrocarbon group having 1 to 20 carbon atoms and more preferably a hydrogen atom.

In addition, provided that q=1, R²⁸ and R²⁹, R²⁹ and R³⁰, or R 30 and R³¹ may be bonded to each other to form a monocyclic or polycyclic ring, and provided that q=2 or 3, R²⁸ and R²⁸, R²⁸ and R²⁹, R²⁹ and R³⁰, R³⁰ and R³¹, or R³¹ and R³¹ may be bonded to each other to form a monocyclic or polycyclic ring. The monocyclic ring or the polycyclic ring may have a double bond, and the monocyclic ring or the polycyclic ring may be an aromatic ring.

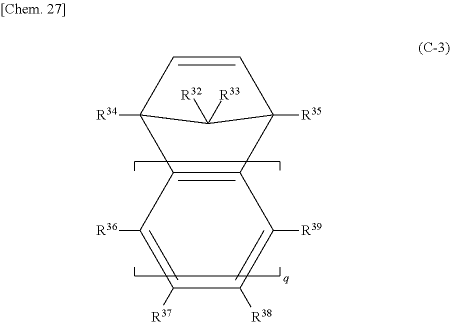

In General Formula (C-3), q is 1, 2, or 3, preferably 1 or 2, and more preferably 1.

R³² to R³⁹ are each independently a hydrogen atom, a halogen atom excluding a fluorine atom, or a hydrocarbon group having 1 to 20 carbon atoms, which may be substituted with a halogen atom excluding a fluorine atom.

R³² to R³⁹ are each independently preferably a hydrogen atom or a hydrocarbon group having 1 to 20 carbon atoms and more preferably a hydrogen atom.

In addition, provided that q=1, R³⁶ and R³⁷, R³⁷ and R³⁸, or R³⁸ and R³⁹ may be bonded to each other to form a monocyclic or polycyclic ring, and provided that q=2 or 3, R³⁶ and R³⁶, R³⁶ and R³⁷, R³⁷ and R³⁸, R³⁸ and R³⁹, or R³⁹ and R³⁹ may be bonded to each other to form a monocyclic or polycyclic ring. The monocyclic ring or the polycyclic ring may have a double bond, and the monocyclic ring or the polycyclic ring may be an aromatic ring.

In addition, examples of the hydrocarbon group having 1 to 20 carbon atoms include, each independently, an alkyl group having 1 to 20 carbon atoms, a cycloalkyl group having 3 to 15 carbon atoms, an aromatic hydrocarbon group, and the like. More specifically, examples of the alkyl group include a methyl group, an ethyl group, a propyl group, an isopropyl group, an amyl group, a hexyl group, an octyl group, a decyl group, a dodecyl group, an octadecyl group, and the like, and examples of the cycloalkyl group include a cyclohexyl group and the like, and examples of the aromatic hydrocarbon group include an aryl group such as a phenyl group, a trill group, a naphthyl group, a benzyl group, and a phenylethyl group, or an aralkyl group and the like. These hydrocarbon groups may be substituted with a halogen atom excluding a fluorine atom.

Among these, the cyclic olefin having an aromatic ring according to the second embodiment of the present invention is preferably, for example, at least one selected from benzonorbornadiene, indene norbornene, and methylphenyl norbornene.

Given that the total content of the repeating unit (AA) and the constituent unit (C) in the cyclic olefin copolymer (A) according to the second embodiment of the present invention is 100% by mol, the upper limit value of the proportion of the repeating unit (C) in the cyclic olefin copolymer (A) is preferably equal to or less than 95% by mol, more preferably equal to or less than 90% by mol, even more preferably equal to or less than 80% by mol, even more preferably equal to or less than 70% by mol, even more preferably equal to or less than 60% by mol, and even more preferably equal to or less than 50% by mol, from the viewpoint of obtaining a molded article having more excellent moist heat resistance, mechanical characteristics, and optical characteristics.

In addition, given that the total content of the repeating unit (AA) and the constituent unit (C) in the cyclic olefin copolymer (A) according to the second embodiment of the present invention is 100% by mol, the lower limit value of the proportion of the repeating unit (C) in the cyclic olefin copolymer (A) is not particularly limited, and for example, equal to or more than 5% by mol from the viewpoint of obtaining a molded article having more excellent moist heat resistance, mechanical characteristics, and optical characteristics.

Furthermore, given that the total content of the repeating unit (AA) and the constituent unit (C) in the cyclic olefin copolymer (A) according to the second embodiment of the present invention is 100% by mol, the proportion of the constituent unit (C) in the cyclic olefin copolymer (A) according to the present embodiment is preferably equal to or more than 5% by mol and equal to or less than 95% by mol, more preferably equal to or more than 5% by mol and equal to or less than 90% by mol, even more preferably equal to or more than 5% by mol and equal to or less than 80% by mol, even more preferably equal to or more than 5% by mol and equal to or less than 70% by mol, even more preferably equal to or more than 5% by mol and equal to or less than 60% by mol, and even more preferably equal to or more than 5% by mol and equal to or less than 50% by mol, from the viewpoint of obtaining a molded article having more excellent moist heat resistance, mechanical characteristics, and optical characteristics.

In the second embodiment of the present invention, the proportion of the constituent unit (C) can be measured by, for example, ¹H-NMR or ¹³C-NMR.

A copolymerization type of the cyclic olefin copolymer (A) according to the second embodiment of the present invention is not particularly limited, and examples thereof include a random copolymer, a block copolymer, and the like. In the present embodiment, it is preferable to use a random copolymer as the cyclic olefin copolymer (A) according to the present embodiment, from the viewpoint capable of obtaining an optical component having excellent transparency and moist heat resistance.

The cyclic olefin copolymer (A) according to the second embodiment of the present invention can be produced, for example, by appropriately selecting conditions according to methods described in Japanese Unexamined Patent Publication No. 60-168708, Japanese Unexamined Patent Publication No. 61-120816, Japanese Unexamined Patent Publication No. 61-115912, Japanese Unexamined Patent Publication No. 61-115916, Japanese Unexamined Patent Publication No. 61-271308, Japanese Unexamined Patent Publication No. 61-272216, Japanese Unexamined Patent Publication No. 62-252406, Japanese Unexamined Patent Publication No. 62-252407, Japanese Unexamined Patent Publication No. 2007-314806, Japanese Unexamined Patent Publication No. 2010-241932, and the like. In addition, as the cyclic olefin copolymer (A) according to the second embodiment, for example, 5013L-10 (manufactured by Polyplastics Co., Ltd.) can be used.

In the first embodiment and second embodiment of the present invention (hereinafter, referred to as the present embodiment), according to ASTM D1238, the lower limit value of a melt flow rate (MFR) of the cyclic olefin copolymer (A) measured at 260° C. and a load of 2.16 kg is preferably equal to or more than 5 g/10 minutes, more preferably equal to or more than 8 g/10 minutes, and even more preferably equal to or more than 10 g/10 minutes from the viewpoint of processability, ease of production of the cyclic olefin copolymer (A), and the like.

The upper limit of the MFR of the cyclic olefin copolymer (A) is, for example, equal to or less than 100 g/10 minutes.

A carbon-carbon double bond is preferably not contained in the cyclic olefin copolymer (A), but in a case where the carbon-carbon double bond is contained, it is preferable to contain equal to or less than 0.5 g of the carbon-carbon double bond in 100 g of the cyclic olefin copolymer (A). The deterioration of the resin composition can be prevented by containing substantially no carbon-carbon double bond, which is preferable. A content of the carbon-carbon double bond in the cyclic olefin copolymer (A) is determined by an iodine value method (titration method) according to JIS K0070.

### (Boric Acid Ester Compound (B))

The boric acid ester compound (B) according to the present embodiment preferably includes a compound represented by Structural Formula (B-1). Accordingly, it possible to improve the moist heat resistance of a molded article obtained without significantly impairing the transparency thereof.

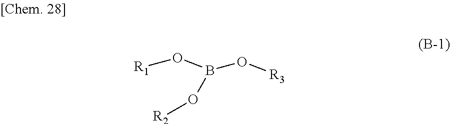

In Structural Formula (B-1), R₁, R₂, and R₃ each represent a functional group having 11 or more carbon atoms, which includes a carbon atom, a hydrogen atom, and an oxygen atom, or a hydrogen atom. At least one of R₁, R₂, or R₃ is a functional group having 11 or more carbon atoms, which includes a carbon atom, a hydrogen atom, and an oxygen atom, and may include a nitrogen atom. In addition, R₁, R₂, and R₃ may form a ring with each other. In other words, R₁ and R₂, R₂ and R₃, or R₃ and R₁ may be bonded to each other to form a monocyclic ring or a polycyclic ring.

Preferred examples of R₁, R₂, and R₃ include a partial structure of a fatty acid glycerin ester or fatty acid diglycerin ester, or hydrogen. By employing these partial structures, the balance between a hydrophilic group and a hydrophobic group in the boric acid ester compound (B) is improved, and as a result, a temperature of the boric acid ester compound (B) at 10% of weight loss is also improved.

Examples of such a compound include tridecyl borate, trimethoxycyclotriboroxane, triphenyl borate, esters formed between boronic acid and 2,3-dihydroxypropyl stearate, and the like. In addition, such a compound may contain a ring structure, such as Chemical Formula (B-1a).

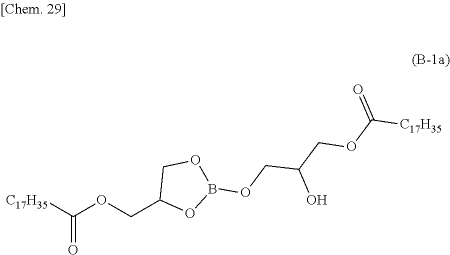

The molecular weight of the boric acid ester compound (B) of the present embodiment is preferably equal to or more than 350 and equal to or less than 2,000, more preferably equal to or more than 400 and equal to or less than 1,900, and even more preferably equal to or more than 500 and equal to or less than 1,800. Provided that the molecular weight is within the above numerical range, the compatibility between the cyclic olefin copolymer (A) and the boric acid ester compound (B) becomes more suitable, and as a result, the moldability and transparency of the cyclic olefin resin composition according to the present embodiment can be further improved.

The lower limit value of the temperature of the boric acid ester compound (B) of the present embodiment at 10% of weight loss, as measured according to JIS K-7120, is preferably equal to or higher than 200° C., more preferably equal to or higher than 225° C., even more preferably equal to or higher than 250° C., and even more preferably equal to or higher than 270° C. Thus, the gasification of the boric acid ester compound during the molding of the cyclic olefin resin composition is controlled, and as a result, the contamination of the mold during the molding can be prevented.

The upper limit value of the temperature of the boric acid ester compound (B) of the present embodiment at 10% of weight loss is not particularly limited, and for example, equal to or lower than 300° C.

The lower limit value of a content of the boric acid ester compound (B) in the cyclic olefin resin composition according to the present embodiment is preferably equal to or more than 0.05 parts by mass, more preferably equal to or more than 0.1 parts by mass, even more preferably equal to or more than 0.5 parts by mass, even more preferably equal to or more than 1.0 parts by mass, even more preferably equal to or more than 1.2 parts by mass, and even more preferably equal to or more than 1.5 parts by mass, given that a content of the cyclic olefin copolymer (A) is 100 parts by mass. Provided that the content of the boric acid ester compound (B) is equal to or more than the above lower limit value, the moist heat resistance of the cyclic olefin resin composition is improved, and the change in transparency before and after molding during molded article production can be suitably prevented.

In addition, the upper limit value of the content of the boric acid ester compound (B) in the cyclic olefin resin composition according to the present embodiment is preferably equal to or less than 10.0 parts by mass, more preferably equal to or less than 7.5 parts by mass, even more preferably equal to or less than 5.0 parts by mass, even more preferably equal to or less than 4.0 parts by mass, even more preferably equal to or less than 3.5 parts by mass, even more preferably equal to or less than 3.0 parts by mass, and even more preferably equal to or less than 2.0 parts by mass, given that a content of the cyclic olefin copolymer (A) is 100 parts by mass. Provided that the content of the boric acid ester compound (B) is equal to or less than the above upper limit value, the transparency of the cyclic olefin resin composition is more suitable.

The boric acid ester compound (B) in the cyclic olefin resin composition of the present embodiment particularly preferably includes a compound represented by Formula (B-2).

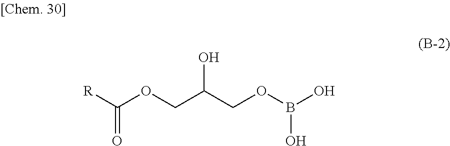

In Formula (B-2), R is an alkyl group or an alkenyl group represented by CₙH₂ₙ₊₁ or CₙH₂ₙ₋₁. In addition, n in R is equal to or more than 8 and equal to or less than 22.

In addition, the boric acid ester compound (B) in the cyclic olefin resin composition of the present embodiment may include a boron compound represented by Formula (B-3).

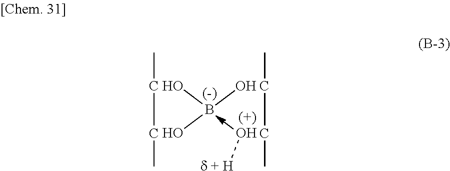

Furthermore, in the cyclic olefin resin composition according to the present embodiment, the boric acid ester compound (B) preferably contains a donor-acceptor compound represented by Formula (B-4) or Formula (B-5), which is obtained by a reaction of the boron compound represented by Formula (B-3) serving as a donor component with a basic nitrogen compound serving as an acceptor component.

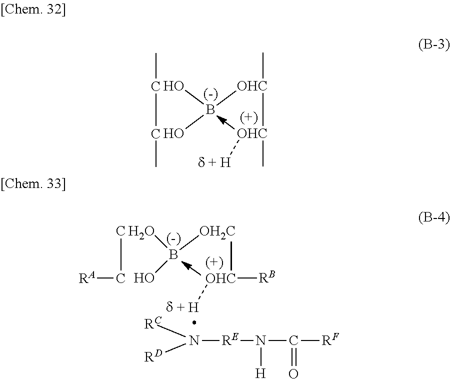

In Formula (B-4), R^{A} and R^{B} are each independently an alkyl group having 8 to 21 carbon atoms (preferably an alkyl group having 10 to 21 carbon atoms), R^{G}CO—OCH₂—, or HOCH₂—, at least one of R^{A} or R^{B} is an alkyl group having 10 to 21 carbon atoms or R^{G}CO—OCH₂—, R^{C} and R^{D} are each independently CH₃—, C₂H₅—, HOCH₂—, HOC₂H₄—, or HOCH₂CH(CH₃)—, R^{E} is CₙH₂ₙ (n is equal to or more than 2 and equal to or less than 10), and R^{F} and R^{G} are each independently an alkyl group having 10 to 21 carbon atoms.

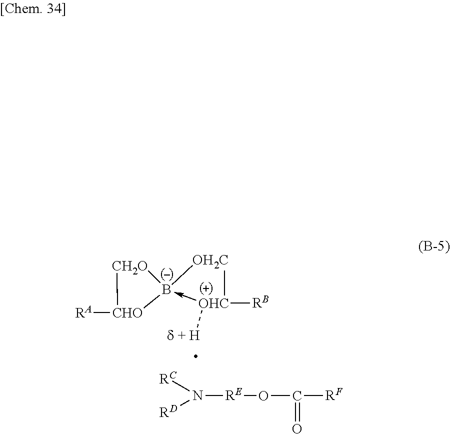

In Formula (B-5), R^{A} and R^{B} are each independently an alkyl group having 8 to 21 carbon atoms (preferably an alkyl group having 10 to 21 carbon atoms), R^{G}CO—OCH₂—, or HOCH₂—, and at least one of R^{A} or R^{B} is an alkyl group having 10 to 21 carbon atoms or R^{G}CO—OCH₂—, R^{C} and R^{D} are each independently CH₃—, C₂H₅—, HOCH₂—, HOC₂H₄—, or HOCH₂CH(CH₃)—, R^{E} is CₙH₂ₙ (n is equal to or more than 2 and equal to or less than 10), and R^{F} and R^{G} are each independently an alkyl group having 10 to 21 carbon atoms.

Such a donor-acceptor compound can be obtained by uniformly mixing at least one of the donor components and at least one of the acceptor components.

In other words, the donor-acceptor compound represented by Formula (B-4) or Formula (B-5) can be obtained by mixing the boron compound represented by Formula (B-3) as a donor component with the basic nitrogen compound as an acceptor component.

Such a donor-acceptor compound is preferably a combination of those that the donor component and acceptor component each have one or more linear hydrocarbon groups. In this case, it is considered that the antistatic effect lasts in the cyclic olefin resin composition, because multiple van der Waals forces act between the boric acid ester compound (B) containing the boron compound and the cyclic olefin copolymer (A) to cause a part that expresses Coulomb force responsible for the antistatic effect of an antistatic agent to remain stable over a long period of time. Although compounds in the donor-acceptor hybrid form based on electron conduction have been known for a long time, these compounds are completely different in mechanism and structure from the donor-acceptor compounds used in the present embodiment.

A semi-polar organic boron compound that is preferably used as the donor component in the present embodiment is obtained by a reaction of boric acid or a boric acid ester of a lower alcohol with remaining adjacent hydroxyl groups of an ester formed between a polyhydric alcohol with the adjacent hydroxyl groups remaining and a linear fatty acid, or a reaction of boric acid or a boric acid ester of a lower alcohol with a linear hydrocarbon compound having adjacent hydroxyl groups, or a reaction of a linear fatty acid with hydroxyl groups remaining after a trihydric or higher polyhydric alcohol having adjacent hydroxyl groups is reacted with boric acid or a boric acid ester of a lower alcohol. The resultant product obtained by this reaction has a feature of being a solid with strong van der Waals forces.

Preferred examples of the polyhydric alcohol or the fatty acid partial ester of the polyhydric alcohol used for preparing the semi-polar organic boron compound (borate ester form complex) constituting the boric acid ester compound (B) according to the present embodiment include glycerin, polyglycerin such as diglycerin, triglycerin, and tetraglycerin, 1,2-alkanediol having 14 to 24 carbon atoms, sorbitol, sorbitan, sucrose, polypentaerythritol such as pentaerythritol, dipentaerythritol, and tripentaerythritol, polyhydric alcohols such as trimethylolethane, trimethylolpropane, polyoxyethylene glycerin, and polyoxyethylene sorbitan, polyglycerin higher fatty acid monoesters such as glycerin higher fatty acid monoester, diglycerin higher fatty acid monoester, triglycerin higher fatty acid monoester, and tetraglycerin higher fatty acid monoester, sorbitol higher fatty acid monoester, sorbitan higher fatty acid monoester, sucrose higher fatty acid monoester, polypentaerythritol higher fatty acid mono- or diesters such as pentaerythritol higher fatty acid mono- or diester, dipentaerythritol higher fatty acid mono- or diester, tripentaerythritol higher fatty acid mono- or diester, and higher fatty acid partial esters of polyhydric alcohols such as trimethylolethane higher fatty acid monoester, trimethylolpropane higher fatty acid monoester, polyoxyethylene glycerin higher fatty acid monoester, polyoxyethylene sorbitan higher fatty acid monoester (higher fatty acids include hexanoic acid, octanoic acid, nonanoic acid, decanoic acid, lauric acid, myristic acid, palmitic acid, stearic acid, behenic acid, montanic acid, oleic acid, erucic acid, and the like). Glycerin higher fatty acid monoesters and pentaerythritol higher fatty acid mono or diesters are particularly preferable.

In addition, the basic nitrogen compound suitable for constituting the boric acid ester compound (B) according to the present embodiment includes N-alkyl substituted primary, secondary, and tertiary amines having at least one linear hydrocarbon group as they are, or those obtained by adding ethylene oxide to primary and secondary amines having at least one linear hydrocarbon group to bond an N-hydroxyethyl substituent, or those obtained by reacting a linear fatty acid with the terminal hydroxyl group of the N-hydroxyethyl substituent, or a linear 2-hydroxy aliphatic amine as it is produced by reacting ammonia with an epoxidized product of a linear hydrocarbon, or those obtained by adding ethylene oxide to primary and secondary linear 2-hydroxy aliphatic amines to bond an N-hydroxyethyl substituent, or those obtained by reacting a polyalkylene polyamine with a linear fatty acid at a molar ratio such that one amino group remains in the polyalkylene polyamine to convert all other amino groups into fatty acid amides, and the like. The feature thereof is a solid with strong van der Waals forces, similar to the semi-polar organic compound described above.

Examples of the basic nitrogen compound (aliphatic amine) suitable for constituting the boric acid ester compound (B) according to the present embodiment include, for example, the following compounds:
octylamine, laurylamine, myristylamine, palmitylamine, stearylamine, oleylamine, cocoamine, tallowamine, soyamine, N,N-dicoamine, N,N-ditallowamine, N,N-disoiamine, N-lauryl-N,N-dimethylamine, N-myristyl-N,N-dimethylamine, N-palmityl-N,N-dimethylamine, N-stearyl-N,N-dimethylamine, N-coco-N,N-dimethylamine, N-tallow-N,N-dimethylamine, N-soy-N,N-dimethylamine, N-methyl-N,N-ditallowamine, N-methyl-N,N-dicocoamine, N-oleyl-1,3-diaminopropane, N-tallow-1,3-diaminopropane, hexamethylene diamine,
N-lauryl-N,N,N-trimethylammonium chloride, N-palmityl-N,N,N-trimethylammonium chloride, N-stearyl-N,N,N-trimethylammonium chloride, N-docosyl-N,N,N-trimethylammonium chloride, N-coco-N,N,N-trimethylammonium chloride, N-tallow-N,N,N-trimethylammonium chloride, N-soy-N,N,N-trimethylammonium chloride, N-lauryl-N,N-dimethyl-N-benzylammonium chloride, N-myristyl-N,N-dimethyl-N-benzylammonium chloride, N-stearyl-N,N-dimethyl-N-benzylammonium chloride, N-coco-N,N-dimethyl-N-benzylammonium chloride, N,N-dioleyl-N,N-dimethylammonium chloride, N,N-dicoco-N,N-dimethylammonium chloride, N,N-ditallow-N,N-dimethylammonium chloride, N,N-disoy-N,N-dimethylammonium chloride, N,N-bis(2-hydroxyethyl)-N-lauryl-N-methylammonium chloride, N,N-bis(2-hydroxyethyl)-N-stearyl-N-methylammonium chloride, N,N-bis(2-hydroxyethyl)-N-oleyl-N-methylammonium chloride, N,N-bis(2-hydroxyethyl)-N-coco-N-methylammonium chloride, N,N-bis(polyoxyethylene)-N-lauryl-N-methylammonium chloride, N,N-bis(polyoxyethylene)-N-stearyl-N-methylammonium chloride, N,N-bis(polyoxyethylene)-N-oleyl-N-methylammonium chloride, N,N-bis(polyoxyethylene)-N-coco-N-methylammonium chloride,
N,N-bis(2-hydroxyethyl)laurylaminobetaine, N,N-bis(2-hydroxyethyl)tridecylaminobetaine, N,N-bis(2-hydroxyethyl)myristylaminobetaine, N,N-bis(2-hydroxyethyl)pentadecylaminobetaine, N,N-bis(2-hydroxyethyl)palmitylaminobetaine, N,N-bis(2-hydroxyethyl)stearylaminobetaine, N,N-bis (2), -hydroxyethyl)oleylaminobetaine, N,N-bis(2-hydroxyethyl)docosylaminobetaine, N,N-bis(2-hydroxyethyl)octacosylaminobetaine, N,N-bis(2-hydroxy), ethyl)cocoaminobetaine, N,N-bis(2-hydroxyethyl)tallowaminobetaine,
hexamethylenetetramine, N-(2-hydroxyethyl)laurylamine, N-(2-hydroxyethyl)tridecylamine, N-(2-hydroxyethyl)myristylamine, N-(2-hydroxyethyl)pentadecylamine, N-(2-hydroxyethyl)palmitylamine, N-(2-hydroxyethyl)stearylamine, N-(2-hydroxyethyl)oleylamine, N-(2-hydroxyethyl)docosylamine, N-(2-hydroxyethyl)octacosylamine, N-(2-hydroxyethyl)cocoamine, N-(2-hydroxyethyl)tallowamine, N-methyl-N-(2-hydroxyethyl)laurylamine, N-methyl-N-(2-hydroxyethyl)tridecylamine, N-methyl-N-(2-hydroxyethyl)myristylamine, N-methyl-N-(2-hydroxyethyl)pentadecylamine, N-methyl-N-(2-hydroxyethyl)palmitylamine, N-methyl-N-(2-hydroxyethyl)stearylamine, N-methyl-N-(2-hydroxyethyl)oleylamine, N-methyl-N-(2-hydroxyethyl)docosylamine, N-methyl-N-(2-hydroxyethyl)octacosylamine, N-methyl-N-(2-hydroxyethyl)cocoamine, N-methyl-N-(2-hydroxyethyl)tallowamine, N,N-bis(2-hydroxyethyl)aliphatic amines such as N,N-bis(2-hydroxyethyl)laurylamine, N,N-bis(2-hydroxyethyl)tridecylamine, N,N-bis(2-hydroxyethyl)myristylamine, N,N-bis(2-hydroxyethyl)pentadecylamine, N,N-bis(2-hydroxyethyl)palmitylamine, N,N-bis(2-hydroxyethyl)stearylamine, N,N-bis(2-hydroxyethyl)oleylamine, N,N-bis(2-hydroxyethyl)docosylamine, N,N-bis(2-hydroxyethyl)octacosylamine, N,N-bis(2-hydroxyethyl)cocoamine, N,N-bis(2-hydroxyethyl)tallowamine;
mono- or diesters of the N,N-bis(2-hydroxyethyl)aliphatic amines with fatty acids such as lauric acid, myristic acid, palmitic acid, stearic acid, oleic acid, behenic acid, and erucic acid, polyoxyethylene aliphatic amino ethers such as polyoxyethylene lauryl amino ether, polyoxyethylene stearyl amino ether, polyoxyethylene oleyl amino ether, polyoxyethylene coco amino ether, and polyoxyethylene tallow amino ether, mono- or diesters of the polyoxyethylene aliphatic amino ethers with the above fatty acids;
N-(lauroyloxyethyl)-N-(stearoyloxyethoxyethyl)stearylamine, N,N,N′,N′-tetra(2-hydroxyethyl)-1,6-diaminohexane, N-lauryl-N, N′,N′-tris(2-hydroxyethyl)-1,3-diaminopropane, N-stearyl-N,N′,N′-tris(2-hydroxyethyl)-1,3-diaminopropane, N-coco-N,N′,N′-tris(2-hydroxyethyl)-1,3-diaminopropane, N-tallow-N,N′,N′-tris(2-hydroxyethyl)-1,3-diaminopropane, N,N-dicoco-N′,N′-bis(2-hydroxyethyl)-1,3-diaminopropane, N,N-ditallow-N′,N′-bis(2-hydroxyethyl)-1,3-diaminopropane, N-coco-N,N′,N′-tris(2-hydroxyethyl)-1,6-diaminohexane, N-tallow-N,N′,N′-tris(2-hydroxyethyl)-1,6-diaminohexane, N,N-dicoco-N′,N′-bis(2-hydroxyethyl)-1,6-diaminohexane, N,N-ditallow-N′,N′-bis(2-hydroxyethyl)-1,6-diaminohexane, N-(2-hydroxyethyl)-2-hydroxylaurylamine, N-(2-hydroxyethyl)-2-hydroxymyristylamine, N-(2-hydroxyethyl)-2-hydroxypalmitylamine, N-(2-hydroxyethyl)-2-hydroxystearylamine, N,N-bis(2-hydroxyethyl)-2-hydroxylaurylamine, N,N-bis(2-hydroxyethyl)-2-hydroxymyristylamine, N,N-bis(2-hydroxyethyl)-2-Hydroxypalmitylamine, N,N-bis(2-hydroxyethyl)-2-hydroxystearylamine, 2,2′-bis(lauric acid amide)diethylamine, 2,2′-bis(myristic acid amide)diethylamine, 2,2′-bis(palmitic acid amide) diethylamine, 2,2′-bis(stearic acid amide)diethylamine, N-(2-(lauric acid amide))ethyl-N-(2′-(stearic acid amide))ethylamine, N-(2-(myristic acid amide))ethyl-N-(2′-(stearic acid amide))ethylamine, N-(3-(lauric acid amide))propyl-N,N-dimethylamine, N-(3-(myristic acid amide))propyl-N,N-dimethylamine, N-(3-(palmitic acid amide))propyl-N,N-dimethylamine, N-(3-(stearic acid amide))propyl-N,N-dimethylamine, N-(3-(lauroyloxy))propyl-N,N-dimethylamine, N-(3-(myristoyloxy))propyl-N,N-dimethylamine, N-(3-(palmitoyloxy))propyl-N,N-dimethylamine, N-(3-(stearoyloxy))propyl-N,N-dimethylamine, N,N-bis(3-(laurateamide)propyl)methylamine, N,N-bis(3-(myristateamide)propyl)methylamine, N,N-bis(3-(palmitic acid amido)propyl)methylamine, N,N-bis(3-(stearamido)propyl)methylamine.

Specific examples of the boric acid ester compound (B), which is such a donor-acceptor compound and suitably used in the present embodiment, are described as Formulae (B-6) to (B-13).

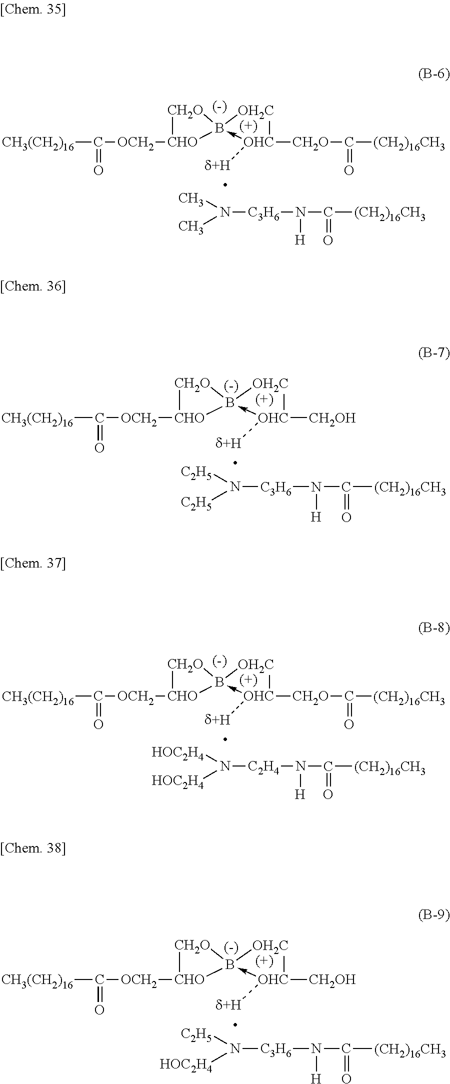

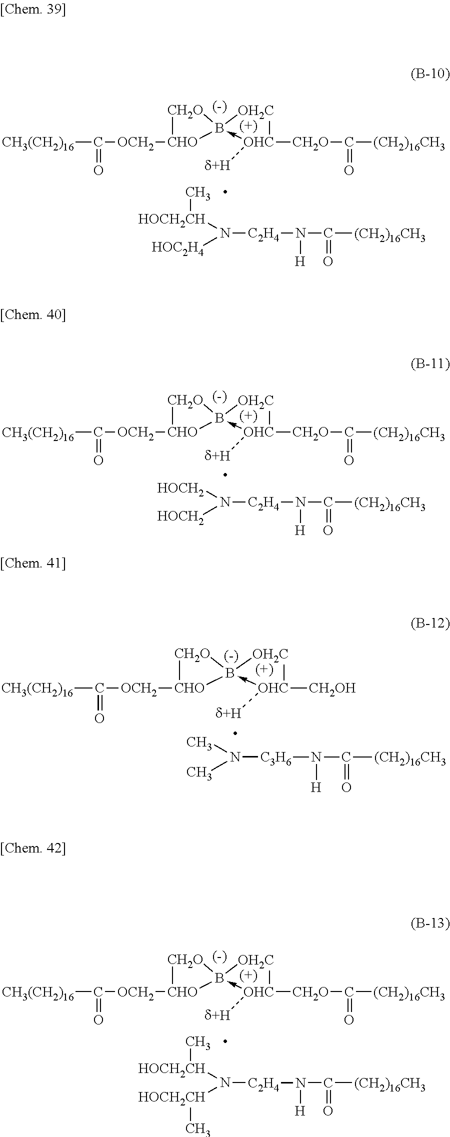

Formulae (B-6) to (B-13) described as examples are donor-acceptor compounds in which the upper semi-polar organic boron compound portion is a donor component, the lower tertiary amine portion is an acceptor component, and both are reacted by a molar ratio of about 1:1. In the above donor component, “δ+” indicates that polarity exists in a covalent bond within the molecule, (+) indicates that the electron donating property of an oxygen atom is stronger, (−) indicates that the electron attracting property of the boron atom is stronger, “→” indicates the path to which electrons are attracted, and “- - -” indicates a state in which the interatomic bonding force is weakened.

The donor-acceptor compound is preferably prepared in advance by mixing and melting and mixing the donor component and the acceptor component at a molar ratio of about 1:1 before mixing with the cyclic olefin copolymer (A). Accordingly, it possible to increase the occurrence of a reaction between both the donor component and the acceptor component in the mixture, and to improve the effect of the present embodiment by promoting the formation of the molecular compound. In addition, the mixing molar ratio of the donor component and the acceptor component is preferably closer to 1:1. When the mixing molar ratio is within a range of about 1:0.8 to 1:1.25, the molecular compound is fully formed. Thus, the effects of the present embodiment can be easily obtained.

The lower limit value of a content of the donor-acceptor compound in the cyclic olefin resin composition according to the present embodiment is preferably equal to or more than 0.05 parts by mass, more preferably equal to or more than 0.1 parts by mass, even more preferably equal to or more than 0.5 parts by mass, even more preferably equal to or more than 1.0 part by mass, and even more preferably equal to or more than 1.5 parts by mass, with respect to 100 parts by mass of the cyclic olefin copolymer (A). Provided that the content of the donor-acceptor compound is equal to or more than the above lower limit value, the moist heat resistance of the cyclic olefin resin composition is improved, and the change in transparency before and after molding during molded article production can be suitably prevented.

In addition, the upper limit value of the content of the donor-acceptor compound in the cyclic olefin resin composition according to the present embodiment is preferably equal to or less than 5.0 parts by mass, more preferably equal to or less than 4.0 parts by mass, even more preferably equal to or less than 3.0 parts by mass, even more preferably equal to or less than 2.0 parts by mass, with respect to 100 parts by mass of the cyclic olefin copolymer (A). Provided that the content of the donor-acceptor compound is equal to or less than the above upper limit value, the transparency of the cyclic olefin resin composition is more suitable.

The donor-acceptor compound suitable as the boric acid ester compound (B), which constitutes the cyclic olefin resin composition according to the present embodiment, a commercially available compound can be used. Specific examples thereof include Biomicelle BN-105 (trade name, mC₄₂H₈₁O₈B+nC₂₃H₄₈ON₂, see product safety data sheet) and Biomicelle BN-77 (trade name, mC₄₂H₈₁O₈B+nC₂₃H₄₇O₂N, see Product safety data sheet), manufactured by Boron Laboratory Co., Ltd.

The lower limit value of a glass transition temperature (Tg) of the cyclic olefin resin composition according to the present embodiment is preferably equal to or higher than 100° C., more preferably equal to or higher than 105° C., and even more preferably equal to or higher than 110° C., from the viewpoint of obtaining sufficient heat resistance when the molded article is used as the optical component, such as in-vehicle camera lenses and camera lenses for mobile devices, which is required to have moist heat resistance.

In addition, the upper limit value of the glass transition temperature (Tg) of the cyclic olefin resin composition according to the present embodiment is preferably equal to or lower than 170° C., more preferably equal to or lower than 165° C., and even more preferably equal to or lower than 160° C., from the viewpoint of obtaining a favorable moldability when the molded article is used as the optical component, such as in-vehicle camera lenses and camera lenses for mobile devices, which is required to have heat resistance.

Furthermore, the glass transition temperature (Tg) of the cyclic olefin resin composition according to the present embodiment is preferably equal to or higher than 100° C. and equal to or lower than 170° C., more preferably equal to or higher than 105° C. and equal to or lower than 165° C., and even more preferably equal to or higher than 110° C. and equal to or lower than 160° C. Since the glass transition temperature (Tg) of the cyclic olefin resin composition is within the above range, sufficient heat resistance can be obtained and improved moldability can be obtained in a case where the molded article is used as an optical component such as in-vehicle camera lenses or camera lenses for mobile devices, which requires moist heat resistance.

Regarding the glass transition temperature (Tg) of the cyclic olefin resin composition according to the present embodiment, the glass transition temperature can be measured when, for example, the temperature of the cyclic olefin resin composition is increased to 200° C. at a temperature increasing rate of 10° C./min from room temperature under a nitrogen atmosphere by using RDC220 manufactured by SII NanoTechnology Inc. and maintained for 5 minutes, and subsequently, the temperature thereof is decreased to 30° C. at a temperature decreasing rate of 10° C./min and maintained for 5 minutes, and then the temperature thereof is increased to 200° C. at a temperature increasing rate of 10° C./min.

### (Other Components)

In addition to the cyclic olefin copolymer (A) and the boric acid ester compound (B), the cyclic olefin resin composition according to the present embodiment contains a known additive as an optional component within a range in which good material properties of the cyclic olefin resin composition according to the present embodiment are not impaired.

Examples of the additive include antioxidants, secondary antioxidants, lubricants, mold release agents, antifogging agents, weather stabilizers, light stabilizers, ultraviolet absorbers, metal inactivating agents, and the like.

The cyclic olefin resin composition according to the present embodiment can be obtained by a method of melt-kneading the cyclic olefin copolymer (A) and the boric acid ester compound (B) using a known kneading apparatus such as an extruder and a Banbury mixer; a method of dissolving the cyclic olefin copolymer (A) and the boric acid ester compound (B) in a common solvent and then evaporating the solvent; a method of adding a solution of the cyclic olefin copolymer (A) and the boric acid ester compound (B) to a poor solvent and precipitating the mixture; and the like.

### [Molded Article and Optical Component]

Next, the molded article of the embodiment according to the present invention will be described.

The molded article according to the present embodiment contains the cyclic olefin resin composition according to the present embodiment.

Since the molded article according to the present embodiment contains the cyclic olefin resin composition according to the present embodiment, the optical performance is excellent. Therefore, the molded article can be suitably used as an optical component in an optical system that needs to identify an image with high accuracy. The optical components are components used in optical system equipment, and the like, and specific examples thereof include lenses for various sensors, pickup lenses, projector lenses, prisms, fθ lenses, imaging lenses, light guide plates, head mount display lenses, and the like. From the viewpoint of the effect according to the present embodiment, the optical components can be suitably used for an fθ lens, imaging lenses, sensor lenses, prisms, or light guide plates.

The method for molding the cyclic olefin resin composition according to the present embodiment to obtain a molded article is not particularly limited, and any known method can be used. Depending on applications and shapes, for example, extrusion molding, injection molding, inflation molding, blow molding, extrusion blow molding, injection blow molding, press molding, vacuum molding, powder slush molding, calendar molding, foam molding, and the like can be applied. Among these, an injection molding method is preferable from the viewpoint of moldability and productivity. Molding conditions are appropriately selected depending on the purpose of use or molding methods, and for example, a resin temperature in the injection molding is usually appropriately selected within a range of 150° C. to 400° C., preferably 200° C. to 350° C., and more preferably 230° C. to 330° C.

As described above, the embodiments of the present invention have been described, but these are examples of the present invention, and various configurations other than the above can be adopted.

In addition, the present invention is not limited to the above described embodiment, and modifications, improvements, and the like within the range in which the object of the present invention can be achieved are included in the present invention.

### EXAMPLES

Hereinafter, the present invention will be described in more detail with reference to Examples, but the present invention is not limited thereto.

### Example 1

### <Cyclic Olefin Copolymer (A1)>

### (Catalyst Preparation)

VO(OC₂H₅)Cl₂ was diluted with cyclohexane to prepare a cyclohexane solution of a vanadium catalyst, which has a vanadium concentration of 6.7 mmol/L. Ethylaluminum sesquichloride (Al(C₂H₅)_{1.5}Cl_{1.5}) was diluted with cyclohexane to prepare a cyclohexane solution of an organoaluminum compound catalyst, which has an aluminum concentration of 107 mmol/L.

### (Polymerization)

A stirring polymerizer (an inner diameter of 500 mm, a reaction volume of 100 L) was used to continuously carry out a copolymerization reaction of ethylene and tetracyclo[4.4.0.1^{2,5}.1^{7,10}]-3-dodecene. Cyclohexane was used as a polymerization solvent. During the copolymerization reaction, the cyclohexane solution of the vanadium catalyst prepared by the above method was supplied such that a vanadium catalyst concentration with respect to cyclohexane in the polymerizer was 0.6 mmol/L.

In addition, ethyl aluminum sesquichloride, which is an organoaluminum compound, was supplied into the polymerizer such that the mass ratio (Al/V) of aluminum to vanadium is 18.0. The copolymerization reaction was continuously carried out under conditions of a polymerization temperature of 8° C. and a polymerization pressure of 1.8 kg/cm² G to obtain a copolymer of ethylene and tetracyclo[4.4.0.1^{2,5}.1^{7,10}]-3-dodecene (ethylene tetracyclo[4.4.0.1^{2,5}.1^{7,10}]-3-dodecene copolymer).

### (Decalcification)

An NaOH solution having a concentration of 25% by mass as water and a pH adjuster was added to a solution of the ethylene tetracyclo[4.4.0.1^{2,5}.1^{7,10}]-3-dodecene copolymer extracted from the polymerizer to stop the polymerization reaction. In addition, a catalyst residue present in the ethylene tetracyclo[4.4.0.1^{2,5}.1^{7,10}]-3-dodecene copolymer was removed (decalcified) to obtain a polymer solution A.

To a cyclohexane solution of the ethylene tetracyclo[4.4.0.1^{2,5}.1^{7,10}]-3-dodecene copolymer subjected to the above decalcification (polymer solution A, polymer concentration of 7.7% by mass) was added pentaerythrityl-tetrakis[3-(3,5-di-t-butyl-4-hydroxyphenyl)propionate] as a stabilizer in an amount of 0.4 parts by mass per 100 parts by mass of the copolymer. Thereafter, the mixture was mixed for 1 hour using a stirring tank with an effective capacity of 1.0 cm³.

### (Desolvent)

The cyclohexane solution of the above copolymer, which has a concentration of 5% by mass, was supplied in an amount of 150 kg/H into a double-tube heater (outer tube diameter of 2B, inner tube diameter of ¾B, and length of 21 m) that uses 20 kg/cm² G of steam as a heat source, and heated to 180° C.

A molten cyclic olefin copolymer (A1) which was flash-dried was obtained by removing most of unreacted monomers together with cyclohexane as a polymerization solvent from the cyclohexane solution of the copolymer that has been heated by using a double-tube flash dryer (outer tube diameter of 2B, inner tube diameter of ¾B, and length of 27 m) that uses 25 kg/cm² G of steam as a heat source and a flash hopper (volume of 200 L). The glass transition temperature (Tg) of the cyclic olefin copolymer (A1) measured using a differential scanning calorimeter was 161° C.

### <Boric Acid Ester Compound (B)>

1 mol of glycerin (manufactured by FUJIFILM Wako Pure Chemical Corporation) and 1 mol of boric acid (manufactured by FUJIFILM Wako Pure Chemical Corporation) were added to a flask, heated to 210° C., and dehydrated for 1 mol. Next, 1 mol of methyl stearate (manufactured by FUJIFILM Wako Pure Chemical Corporation) was added to the flask, and a transesterification reaction is carried out at 230° C. to 240° C. to remove the methanol, thereby obtaining a boric acid ester compound represented by Formula (1).

The temperature of the compound represented by Formula (1) at 10% of weight loss, which was measured by a method in <Temperature at 10% of Weight Loss> described later, was 272° C.

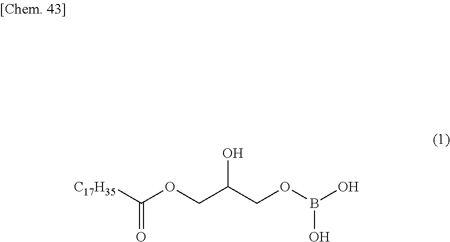

### (Extrusion)

The molten cyclic olefin copolymer (A1) was charged into a resin insertion site of a twin screw kneading extruder with a vent. Next, while a vacuum pump sucked from the vent site through a trap for the purpose of removing a volatile, 1.5 parts by mass of the boric acid ester compound represented by Formula (1) was added to a cylinder portion disposed closer to downstream than the vent site with respect to 100 parts by mass of the cyclic olefin copolymer (A1) and kneaded at a position closer to downstream of the extruder than the vent site. At this time, the condition of the extruder was adjusted so that the difference between the maximum value and the minimum value of the resin temperature in the extruder diverter portion is within 3° C.

### Example 2

A resin composition was produced in the same manner as in Example 1 except that the addition amount of the boric acid ester compound represented by Formula (1) in [Example 1] was 3.0 parts by mass with respect to 100 parts by mass of the cyclic olefin copolymer (A1).

### Example 3

A resin composition was produced in the same manner as in Example 1 except that the addition amount of the boric acid ester compound represented by Formula (1) in [Example 1] was 5.0 parts by mass with respect to 100 parts by mass of the cyclic olefin copolymer (A1).

### Example 4

A resin composition was produced in the same manner as in Example 1 except that a mixture represented by Formula (2) (Biomicelle BN-105: manufactured by Boron Laboratory Co., Ltd., a donor-acceptor compound represented by General Formula (B-4)), which was obtained by mixing the following boric acid ester and the basic compound at a molar ratio of 1:1 was used in place of the boric acid ester compound represented by Formula (1) in [Example 1], and the addition amount of the mixture represented by Formula (2) was 1.5 parts by mass with respect to 100 parts by mass of the cyclic olefin copolymer (A1).

The temperature of the mixture represented by Formula (2) at 10% of weight loss, which was measured by a method in <Temperature at 10% of Weight Loss> described later, was 289° C.

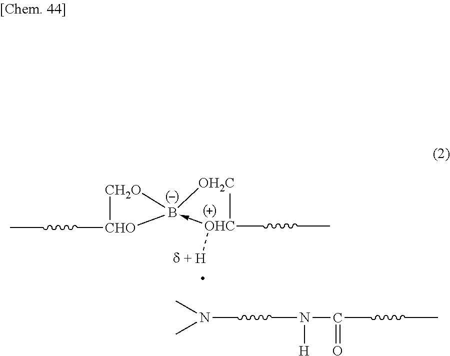

### Example 5

A resin composition was produced in the same manner as in Example 1 except that the addition amount of the mixture represented by Formula (2) in [Example 4] was 2.5 parts by mass with respect to 100 parts by mass of the cyclic olefin copolymer (A1).

### Example 6

The cyclic olefin copolymer (A2) (5013L-10, manufactured by Polyplastics Co., Ltd.) was charged into a resin insertion site of a twin screw kneading extruder with a vent, 2.0 parts by mass of the boric acid ester compound represented by Formula (1) was added to a cylinder portion disposed closer to downstream than the vent site with respect to 100 parts by mass of the cyclic olefin copolymer (A2) and kneaded at a position closer to downstream of the extruder than the vent site. At this time, the condition of the extruder was adjusted so that the difference between the maximum value and the minimum value of the resin temperature in the extruder diverter portion is within 3° C.

### Example 7

A resin composition was produced in the same manner as in Example 6 except that the addition amount of the boric acid ester compound represented by Formula (1) in [Example 6] was 3.0 parts by mass with respect to the cyclic olefin copolymer (A2).

### Example 8

A resin composition was produced in the same manner as in Example 6 except that the mixture represented by Formula (2) was used in place of the boric acid ester compound represented by Formula (1) in [Example 6], and the addition amount of the mixture represented by Formula (2) was 2.0 parts by mass with respect to the cyclic olefin copolymer (A2).

### Example 9

A resin composition was produced in the same manner as in Example 8 except that the addition amount of the mixture represented by Formula (2) in [Example 8] was 3.0 parts by mass with respect to the cyclic olefin copolymer (A2).

### Comparative Example 1

A resin composition was produced in the same manner as in Example 1 except that a compound represented by Formula (3) (2,3-di-o-benzyl-d-glucopyranose, manufactured by Combi-Blocks Inc.) was used in place of the boric acid ester compound represented by Formula (1) in [Example 1], and the addition amount of the compound represented by Formula (3) was 1.0 part by mass with respect to 100 parts by mass of the cyclic olefin copolymer (A1).

The temperature of the compound represented by Formula (3) at 10% of weight loss, which was measured by a method in <Temperature at 10% of Weight Loss> described later, was 243° C.

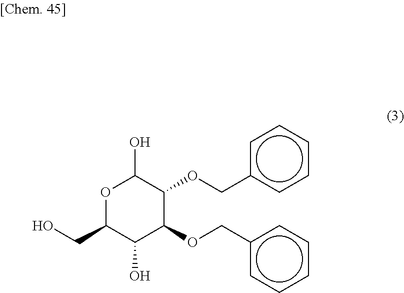

### Comparative Example 2

A resin composition was produced in the same manner as in [Example 1] except that the boric acid ester compound represented by Formula (1) in [Example 1] was not added.

### Comparative Example 3

A resin composition was produced in the same manner as in [Example 6] except that the boric acid ester compound represented by Formula (1) in [Example 6] was not added.

Each of Examples and Comparative Examples was evaluated by the following method. The results are described in Table 1.

### <Temperature at 10% of Weight Loss>

The measurement was carried out according to JIS K-7120 using TG-DTA7300 (manufactured by Seiko Instruments Inc.). The temperature at which the rate of weight loss of the TG curve was 10% was defined as a temperature at 10% of weight loss.

### <Internal Haze>

The obtained resin composition was injection-molded at a cylinder temperature of 275° C. and a mold temperature of 120° C. using an injection molding machine (ROBOSHOT S2000i-30α, manufactured by FANUC CORPORATION) to mold a test piece having an optical surface of 35 mm×65 mm×a thickness of 3 mmt.

The internal haze of the test piece was measured in benzyl alcohol based on JIS K-7105 using a haze meter HM-150 manufactured by Murakami Color Research Laboratory.

### <Moist Heat Resistance Test>

Each test piece produced by the internal haze measurement was left to stand for 168 hours in an atmosphere at a temperature of 85° C. and a relative humidity of 95%. Thereafter, the test piece was taken out to an atmosphere at a temperature of 23° C. and a relative humidity of 50% and left to stand for 48 hours, after which the internal haze was measured.

Then, the amount of change obtained by subtracting the internal haze before the moist heat resistance test from the internal haze after the moist heat resistance test was measured as a Δ internal haze.

### <Mold Contamination>

An injection molding machine (ROBOSHOT S200i-30α, manufactured by FANUC CORPORATION) was prepared and a mold for forming a flat lens having a lens diameter of 6.0 mm and a lens thickness of 0.5 mm was prepared as a mold.

Using this mold, the resin compositions obtained in Examples and Comparative Examples were injection-molded under the conditions of a cylinder temperature of 285° C. and a mold temperature of 105° C., and a total of 4,500 injection moldings was carried out.

After 4,500 injection moldings, the contamination on the lens surface of the mold was observed with a digital microscope VHX-5000 (manufactured by KEYENCE CORPORATION), and the contamination was visually evaluated according to the following standards.

A (slight): Contamination is observed only at a gate portion.

B (slightly excessive): Contamination is observed from the gate to an intermediate portion of a runner.

C (excessive): Contamination is observed all over the runner portion.

TABLE 1

| | Content | | | Content | | | | | |
|---|---|---|---|---|---|---|---|---|---|
| | [parts by | | | [parts by | Content | Internal | Internal | | |
| | mass] of | Kind of | Kind of | mass] of | [parts by | haze | haze | | |
| | cyclic | cyclic | boric | boric | mass] of | (before | (after | | |
| | olefin | olefin | acid | acid | compound | moist heat | moist heat | | |
| | random | random | ester | ester | represented | resistance | resistance | | |
| | copolymer | copolymer | compound | compound | by Formula | test) | test) | ΔInternal | Mold |
| | (A) | (A) | (B) | (B) | (3) | [%] | [%] | haze | contamination |
| Example 1 | 100 | A1 | Formula (1) | 1.5 | — | 0.2 | 0.3 | 0.1 | A |
| Example 2 | 100 | A1 | Formula (1) | 3.0 | — | 0.2 | 0.3 | 0.1 | A |
| Example 3 | 100 | A1 | Formula (1) | 5.0 | — | 4.2 | 4.2 | 0.0 | B |
| Example 4 | 100 | A1 | Formula (2) | 1.5 | — | 0.2 | 0.9 | 0.7 | A |
| Example 5 | 100 | A1 | Formula (2) | 2.5 | — | 0.1 | 0.1 | 0.0 | A |
| Example 6 | 100 | A2 | Formula (1) | 2.0 | — | 0.6 | 0.6 | 0.0 | A |
| Example 7 | 100 | A2 | Formula (1) | 3.0 | — | 0.5 | 0.7 | 0.1 | A |
| Example 8 | 100 | A2 | Formula (2) | 2.0 | — | 0.4 | 0.4 | 0.0 | A |
| Example 9 | 100 | A2 | Formula (2) | 3.0 | — | 1.2 | 1.2 | 0.0 | A |
| Comparative | 100 | A1 | — | — | 1.0 | 2.3 | 2.3 | 0.0 | C |
| Example 1 | | | | | | | | | |
| Comparative | 100 | A1 | — | — | — | 0.5 | 10.0 | 9.5 | — |
| Example 2 | | | | | | | | | |
| Comparative | 100 | A2 | — | — | — | 0.2 | 11.0 | 10.8 | — |
| Example 3 | | | | | | | | | |

In Examples 1 to 9, the moist heat resistance was excellent and the mold contamination was small. Furthermore, in Examples of the content of the boric acid ester compound (B) of 3.0 parts by mass or less, the value of the internal haze before the moist heat resistance test was also suitable in addition to the moist heat resistance and the mold contamination, and the transparency was excellent.

In contrast, in Comparative Example 1, the mold contamination generated excessively. In addition, in Comparative Examples 2 and 3, the A internal haze was increased, and the moist heat resistance was poor. In Comparative Examples 2 and 3, the mold contamination was not evaluated because the moist heat resistance was not exhibited.

This application claims priority based on Japanese Patent Application No. 2022-018537 filed on Feb. 9, 2022, the entire disclosure of which is incorporated herein.

1. A cyclic olefin resin composition comprising:
a cyclic olefin copolymer (A); and
a boric acid ester compound (B).

2. The cyclic olefin resin composition according to claim 1,
wherein the cyclic olefin copolymer (A) has a repeating unit (a) derived from at least one olefin represented by General Formula (1), and a repeating unit (b) derived from at least one cyclic olefin monomer selected from the group consisting of a repeating unit (AA) represented by General Formula (II), a repeating unit (AB) represented by General Formula (III), and a repeating unit (AC) represented by General Formula (IV), 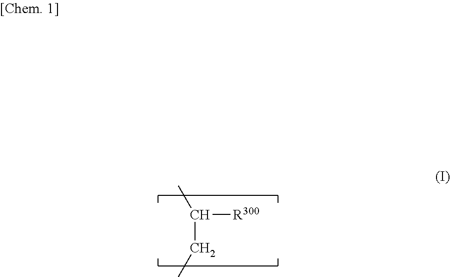
(in General Formula (1), R³⁰⁰ represents a hydrogen atom or a linear or branched hydrocarbon group having 1 to 29 carbon atoms), 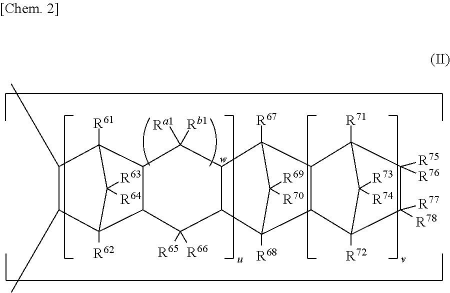
(in General Formula (II), u is 0 or 1, v is 0 or a positive integer, w is 0 or 1, R⁶¹ to R⁷⁸ and R^{a1} and R^{b1} may be the same or different from each other and are each a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded to each other to form a monocyclic ring or a polycyclic ring), 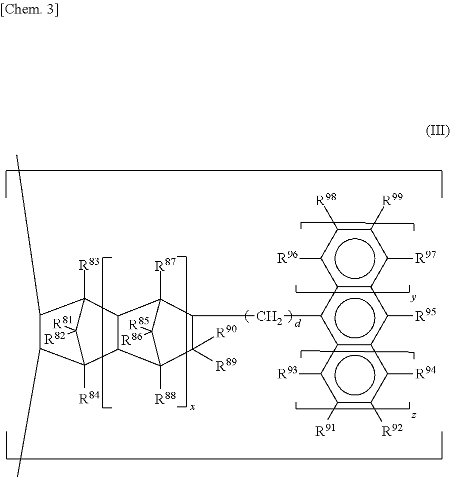
(in General Formula (III), x and d are each 0 or an integer of equal to or more than 1, y and z are each 0, 1, or 2, R⁸¹ to R⁹⁹ may be the same or different from each other and are each a hydrogen atom, a halogen atom, an aliphatic hydrocarbon group that is an alkyl group having 1 to 20 carbon atoms or a cycloalkyl group having 3 to 15 carbon atoms, an aromatic hydrocarbon group having 6 to 20 carbon atoms or an alkoxy group, a carbon atom to which R⁸⁹ and R⁹⁰ are bonded may be bonded to a carbon atom to which R⁹³ is bonded or a carbon atom to which R⁹¹ is bonded directly or through an alkylene group having 1 to 3 carbon atoms, and provided that y=z=0, R⁹⁵ and R⁹² or R⁹⁵ and R⁹⁹ may be bonded to each other to form a monocyclic aromatic ring or a polycyclic aromatic ring), 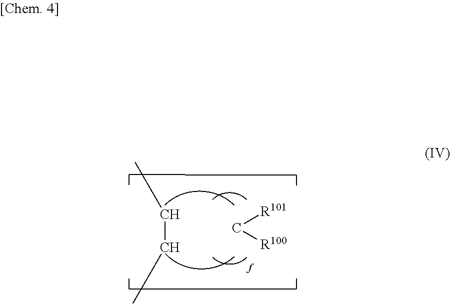
(in General Formula (IV), R¹⁰⁰ and R¹⁰¹ may be the same or different from each other and each represent a hydrogen atom or a hydrocarbon group having 1 to 5 carbon atoms, and f is 1≤f≤18).

3. The cyclic olefin resin composition according to claim 1,
wherein the cyclic olefin copolymer (A) has the repeating unit (AA) represented by General Formula (II), and a constituent unit (C) derived from a cyclic olefin having an aromatic ring,
the repeating unit (AA) has no aromatic ring, and
the cyclic olefin having an aromatic ring includes one or two or more compounds selected from the group consisting of a compound represented by General Formula (C-1), a compound represented by General Formula (C-2), and a compound represented by General Formula (C-3), 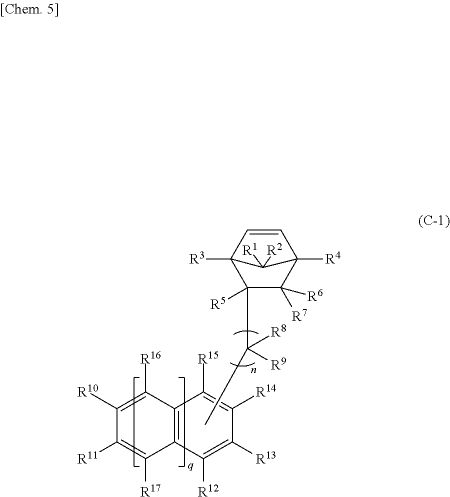
(in General Formula (C-1), n and q are each independently 0, 1, or 2; R¹ to R¹⁷ are each independently a hydrogen atom, a halogen atom other than a fluorine atom, or a hydrocarbon group having 1 to 20 carbon atoms which may be substituted with a halogen atom other than a fluorine atom, and one of R¹⁰ to R¹⁷ is a bonding site, provided that q=0, R¹⁰ and R¹¹, R¹¹ and R¹², R¹² and R¹³, R¹³ and R¹⁴, R¹⁵ and R¹⁵, or R¹⁵ and R¹⁰ may be bonded to each other to form a monocyclic ring or a polycyclic ring, and provided that q=1 or 2, R¹⁰ and R¹¹, R¹¹ and R¹⁷, R¹⁷ and R¹⁷, R¹⁷ and R¹², R¹² and R¹³, R¹³ and R¹⁴, R¹⁴ and R¹⁵, R¹⁵ and R¹⁶, R¹⁶ and R¹⁶, or R¹⁶ and R¹⁰ may be bonded to each other to form a monocyclic ring or a polycyclic ring, where the monocyclic ring or the polycyclic ring may have a double bond, and the monocyclic ring or the polycyclic ring may be an aromatic ring), 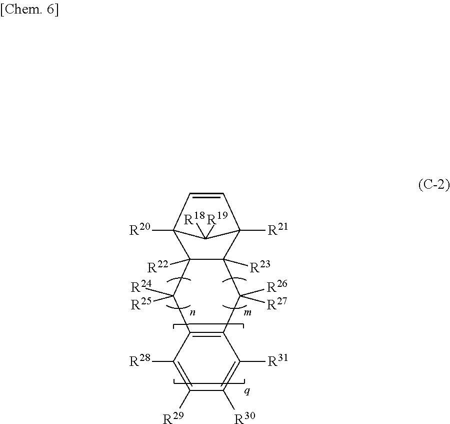
(in General Formula (C-2), n and m are each independently 0, 1, or 2, q is 1, 2, or 3, R¹⁸ to R³¹ are each independently a hydrogen atom, a halogen atom other than a fluorine atom, or a hydrocarbon group having 1 to 20 carbon atoms which may be substituted with a halogen atom other than a fluorine atom, provided that q=1, R²⁸ and R²⁹, R²⁹ and R³⁰, and R³⁰ and R³¹ may be bonded to each other to form a monocyclic ring or a polycyclic ring, and provided that q=2 or 3, R²⁸ and R²⁸, R²⁸ and R²⁹, R²⁹ and R³⁰, R³⁰ and R³¹, and R³¹ and R³¹ may be bonded to each other to form a monocyclic ring or a polycyclic ring, where the monocyclic ring or the polycyclic ring may have a double bond, and the monocyclic ring or the polycyclic ring may be an aromatic ring), 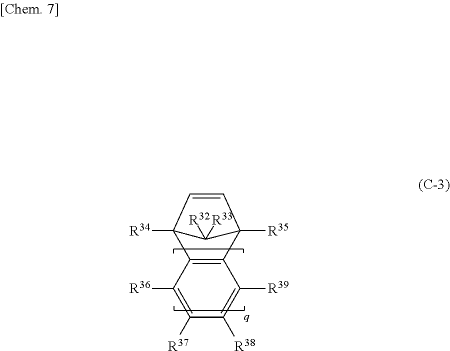
(in General Formula (C-3), q is 1, 2, or 3, R³² to R³⁹ are each independently a hydrogen atom, a halogen atom excluding a fluorine atom, or a hydrocarbon group having 1 to 20 carbon atoms, which may be substituted with a halogen atom excluding a fluorine atom, and provided that q=1, R³⁶ and R³⁷, R³⁷ and R³⁸, and R³⁸ and R³⁹ may be bonded to each other to form a monocyclic ring or a polycyclic ring and provided that q=2 or 3, R³⁶ and R³⁶, R³⁶ and R³⁷, R³⁷ and R³⁸, R³⁸ and R³⁹, and R³⁹ and R³⁹ may be bonded to each other to form a monocyclic ring or a polycyclic ring, where the monocyclic ring or the polycyclic ring may have a double bond, and the monocyclic ring or the polycyclic ring may be an aromatic ring).

4. The cyclic olefin resin composition according to claim 1,
wherein the boric acid ester compound (B) includes a compound represented by Structural Formula (B-1), 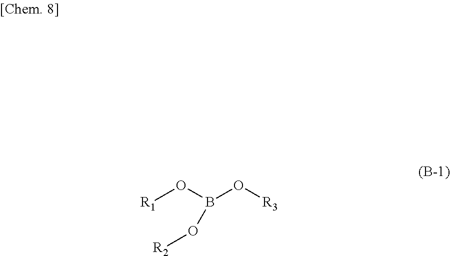
(in Structural Formula (B-1), R₁, R₂, and R₃ each represent a functional group having 11 or more carbon atoms, which includes a carbon atom, a hydrogen atom, and an oxygen atom, or a hydrogen atom, at least one of R₁, R₂, or R₃ is a functional group having 11 or more carbon atoms, which includes a carbon atom, a hydrogen atom, and an oxygen atom, and may include a nitrogen atom, and R₁, R₂, and R₃ may form a ring with each other).

5. The cyclic olefin resin composition according to claim 1,
wherein a content of the boric acid ester compound (B) is equal to or more than 0.05 parts by mass and equal to or less than 10.0 parts by mass, given that a content of the cyclic olefin copolymer (A) contained in the cyclic olefin resin composition is 100 parts by mass.

6. The cyclic olefin resin composition according to claim 1,
wherein the boric acid ester compound (B) includes a compound represented by Formula (B-2), 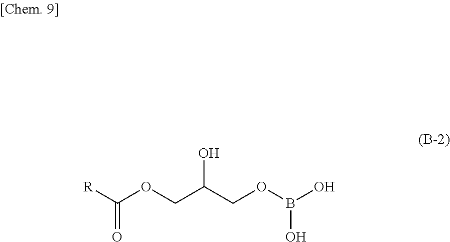
(in Formula (B-2), R is an alkyl group or an alkenyl group represented by CₙH₂ₙ₊₁ or CₙH₂ₙ₋₁, and n in R is equal to or more than 8 and equal to or less than 22).

7. The cyclic olefin resin composition according to claim 1,
wherein the boric acid ester compound (B) includes a donor-acceptor compound represented by Formula (B-4) or Formula (B-5), 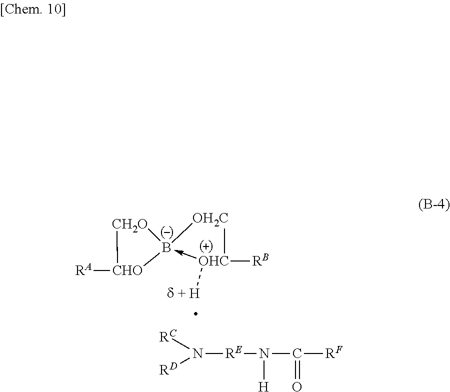
(in Formula (B-4), R^{A} and R^{B} are each independently an alkyl group having 8 to 21 carbon atoms, R^{G}CO—OCH₂—, or HOCH₂—, at least one of R^{A} or R^{B} is an alkyl group having 10 to 21 carbon atoms or R^{G}CO—OCH₂—, R^{C} and R^{D} are each independently CH₃—, C₂H₅—, HOCH₂—, HOC₂H₄—, or HOCH₂CH(CH₃)—, R^{E} is CₙH₂ₙ (n is equal to or more than 2 and equal to or less than 10), and R^{F} and R^{G} are each independently an alkyl group having 10 to 21 carbon atoms), 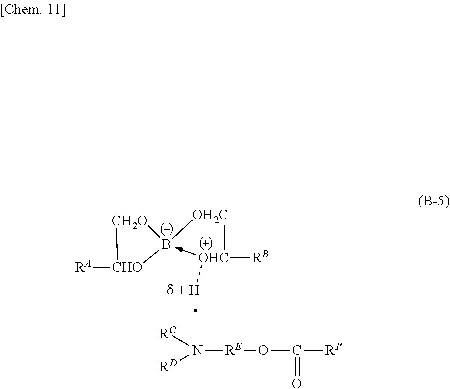
(in Formula (B-5), R^{A} and R^{B} are each independently an alkyl group having 8 to 21 carbon atoms, R^{G}CO—OCH₂—, or HOCH₂—, at least one of R^{A} or R^{B} is an alkyl group having 10 to 21 carbon atoms or R^{G}CO—OCH₂—, R^{C} and R^{D} are each independently CH₃—, C₂H₅—, HOCH₂—, HOC₂H₄—, or HOCH₂CH(CH₃)—, R^{E} is CₙH₂ₙ (n is equal to or more than 2 and equal to or less than 10), and R^{F} and R^{G} are each independently an alkyl group having 10 to 21 carbon atoms).

8. A molded article comprising the cyclic olefin resin composition according to claim 1.

9. An optical component comprising the molded article according to claim 8.
